(19) United States
(12) Patent Application Publication
(10) Pub. No.: US 2017/0091532 A1
(43) Pub. Date: Mar. 30, 2017

(54) ELECTRONIC DEVICE FOR PROCESSING IMAGE AND CONTROL METHOD THEREOF

(71) Applicant: Samsung Electronics Co., Ltd., Gyeonggi-do (KR)

(72) Inventors: Dong-Il SON, Gyeonggi-do (KR); Chi-Hyun CHO, Gyeonggi-do (KR); Chang-Ryong HEO, Gyeonggi-do (KR); Seung-Nyun KIM, Incheon (KR); Je-Han YOON, Gyeonggi-do (KR); So-Young LEE, Gyeonggi-do (KR)

(21) Appl. No.: 15/238,404

(22) Filed: Aug. 16, 2016

(30) Foreign Application Priority Data
Sep. 30, 2015 (KR) 10-2015-0137676

(51) Int. Cl. G06K 9/00; G06T 7/00

(52) U.S. Cl. CPC G06K 9/00288; G06K 9/00664; G06T 7/0081; G06K 9/00281; G06K 9/00268; G06T 2207/10004; G06K 2009/00328; G06K 2209/27; G06K 9/00302; G06K 9/00342

(57) ABSTRACT

Disclosed is an electronic device that acquires an image including a first object, identifies a first part of the first object in the image, identifies a second part related to the first part based on a result of the identification of the first part, and performs an operation based on a result of the identification of the second part when the instructions are executed.

### PRIORITY

This application claims priority under 35 U.S.C. §119(a) to a Korean Patent Application which was filed in the Korean Intellectual Property Office on Sep. 30, 2015 and assigned Serial No. 10-2015-0137676, the contents of which are incorporated herein by reference.

### BACKGROUND

1. Field of the Disclosure

The present disclosure relates generally to an electronic device and, more particularly, to an electronic device for processing an image photographed or acquired through communication and a method of controlling the same.

2. Description of the Related Art

There has been an abundance of recent development in technology for analyzing an image. The conventional image analysis technology identifies an object within an image by photographing the image and then applying a preset algorithm to the photographed image. For example, the conventional image analysis technology compares a pre-stored object template with an image and identifies an object which is very similar with the template within the image, and to identify a particular object. The conventional image analysis technology pre-stores various types of templates for human faces, detects an object corresponding to a face in an image generated by photographing a person, stores templates for the face according to the user and, when an object which is very similar is found, performs a user authentication.

The conventional image analysis technology identifies one object within an image and provides various feedback using a result of the identification. However, the conventional image analysis technology cannot identify other parts which are not part of a particular object within an image. Accordingly, the conventional image analysis technology provides only simple and limited information on the image.

As such, there is a need in the art for an improved image analysis technology that provides more expansive information on the image.

### SUMMARY

The present disclosure has been made to solve the above described problems or other problems in the prior art and to provide the advantages described below.

Accordingly, an aspect of the present disclosure is to provide an electronic device for identifying not only a particular part of an image, but also, for identifying other parts related to the particular part and storing or using an identification result, and a control method thereof.

In accordance with an aspect of the present disclosure, an electronic device includes a processor, and a memory electrically connected to the processor, wherein the memory stores instructions to instruct the processor to acquire an image including a first object, to identify a first part of the first object in the image, to identify a second part of the first object, related to the first part, based on a result of the identification of the first part, and to perform an operation based on a result of the identification of the second part when the instructions are executed.

In accordance with another aspect of the present disclosure, an electronic device includes a processor, and a memory electrically connected to the processor, wherein the memory stores instructions to instruct the processor to acquire an image including a first object, to identify a first part of the first object in the image, to identify a second part related to the first part based on an identification result of the first part, and to store the identification result of the first part and an identification result of the second part to be associated with each other when the instructions are executed.

In accordance with another aspect of the present disclosure, an electronic device includes a processor, and a memory electrically connected to the processor, wherein the memory stores instructions to instruct the processor to acquire a plurality of images including a first object, to identify a first part of the first object in each of the plurality of images, to identify a second part related to the first part in each of the plurality of images based on an identification result of the first part, and to perform an operation based on an identification result of the second part when the instructions are executed.

In accordance with another aspect of the present disclosure, an electronic device includes a processor and a memory electrically connected to the processor, wherein the memory stores instructions to instruct the processor to acquire an image and to perform an operation related to at least one part of the image based on a type of a first object included in the image when the instructions are executed.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1A is a block diagram illustrating an electronic device and a network according to embodiments of the present disclosure;

FIG. 1B illustrates an implementation example according to embodiments of the present disclosure;

FIG. 2A is a block diagram of an electronic device according to embodiments of the present disclosure;

FIG. 2B is a block diagram of an electronic device according to embodiments of the present disclosure;

FIG. 3 is a block diagram of a program module according to embodiments of the present disclosure;

FIG. 4 illustrates a control method of an electronic device according to embodiments of the present disclosure;

FIGS. 5A and 5B illustrate an acquired image according to embodiments of the present disclosure;

FIG. 5C illustrates the electronic device according to embodiments of the present disclosure;

FIG. 5D illustrates an area to be identified according to embodiments of the present disclosure;

FIGS. 6A, 6B, 6C and 6D illustrate a processing process related to different types of first parts according to embodiments of the present disclosure;

FIG. 7 illustrates a control method of the electronic device according to embodiments of the present disclosure;

FIG. 8 illustrates a data structure of a stored identification result according to embodiments of the present disclosure;

FIGS. 9A and 9B illustrate a control method of the electronic device according to embodiments of the present disclosure;

FIG. 10 illustrates a data structure of a stored identification result according to embodiments of the present disclosure;

FIGS. 11A, 11B, 11C, 11D and 11E illustrate an output message converting process according to embodiments of the present disclosure;

FIG. 12 illustrates a control method of the electronic device according to embodiments of the present disclosure;

FIG. 13 illustrates a message conversion of the electronic device according to embodiments of the present disclosure;

FIGS. 14A, 14B and 14C illustrate image processing according to embodiments of the present disclosure;

FIG. 15 illustrates a control method of the electronic device according to embodiments of the present disclosure;

FIG. 16 illustrates a control method of the electronic device according to embodiments of the present disclosure;

FIG. 17 illustrates a control method of the electronic device according to embodiments of the present disclosure;

FIG. 18 illustrates a control method of the electronic device according to embodiments of the present disclosure;

FIG. 19 illustrates an authentication process according to embodiments of the present disclosure;

FIGS. 20A and 20B illustrate a control method of the electronic device according to embodiments of the present disclosure;

FIG. 21 illustrates additional information processing according to embodiments of the present disclosure;

FIGS. 22A, 22B and 22C illustrate additional information processing according to embodiments of the present disclosure;

FIG. 23 illustrates additional information processing according to embodiments of the present disclosure;

FIG. 24 illustrates additional information processing according to embodiments of the present disclosure;

FIG. 25 illustrates additional information processing according to embodiments of the present disclosure;

FIG. 26 illustrates additional information processing according to embodiments of the present disclosure;

FIG. 27 illustrates a control method of the electronic device according to embodiments of the present disclosure;

FIGS. 28A to 28C illustrate additional information processing of a place according to embodiments of the present disclosure;

FIG. 29 illustrates a control method of the electronic device according to embodiments of the present disclosure;

FIGS. 30A and 30B illustrate image processing according to embodiments of the present disclosure;

FIG. 31 illustrates a control method of the electronic device according to embodiments of the present disclosure;

FIGS. 32A and 32B illustrate image processing according to embodiments of the present disclosure;

FIG. 33 illustrates a control method of the electronic device according to embodiments of the present disclosure; and

FIG. 34 illustrates a control method of the electronic device according to embodiments of the present disclosure.

### DETAILED DESCRIPTION OF EMBODIMENTS OF THE DISCLOSURE

Hereinafter, embodiments of the present disclosure will be described with reference to the accompanying drawings. However, there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

The expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expressions “a first”, “a second”, “the first”, and “the second” may modify various components regardless of the order and/or the importance, but do not limit the corresponding components. For example, a first user device and a second user device indicate different user devices although both of them are user devices. A first element may be referred to as a second element, and similarly, a second element may be referred to as a first element, without departing from the scope of the present disclosure.

When an element, referred to as a first element, is referred to as being operatively or communicatively “connected,” or “coupled,” to another element, referred to as a second element, the first element may be directly connected or coupled directly to the second element or any other element, referred to as a third element, may be interposer between the first and second elements. In contrast, when the first element is referred to as being “directly connected,” or “directly coupled” to the second element, there is no third element interposed between the first and second elements.

The expression “configured to” may be exchanged with “suitable for”, “having the capacity to”, “designed to”, “adapted to”, “made to”, or “capable of”, for example, according to context. The term “configured to” may not necessarily imply “specifically designed to” in hardware. Alternatively, in some situations, the expression “device configured to” may indicate that the device, together with other devices or components, “is able to”. For example, the phrase “processor adapted (or configured) to perform A, B, and C” may indicate a dedicated processor (e.g., embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meanings as those commonly understood by a person skilled in the art to which the present disclosure pertains. Such terms as those defined in a commonly used dictionary may be interpreted to have the same meanings as the contextual meanings in the relevant field of art, and are not to be interpreted to have ideal or excessively formal meanings unless clearly defined as such in the present disclosure. In some cases, even the terms defined in the present disclosure should not be interpreted to exclude embodiments of the present disclosure.

An electronic device according to embodiments of the present disclosure may include at least one of a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a motion pictures experts group (MPEG)-1 audio layer-3 (MP3) player, a mobile medical device, a camera, and a wearable device. According to embodiments, the wearable device may include at least one of an accessory type, such as a watch, a ring, a bracelet, an anklet, a necklace, a glasses, a contact lens, or a head-mounted device (HMD), a fabric or clothing integrated type such as electronic clothing, a body-mounted type such as a skin pad or tattoo, and a bio-implantable type such as an implantable circuit.

The electronic device may also be a home appliance such as a television, a digital video disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™, an electronic dictionary, an electronic key, a camcorder, and an electronic photo frame.

The electronic device may also include at least one of various portable medical measuring devices such as a blood glucose monitoring device, a heart rate monitoring device, a blood pressure measuring device, a body temperature measuring device, a magnetic resonance angiography (MRA) device, a magnetic resonance imaging (MRI) device, a computed tomography (CT) machine, and an ultrasonic machine, a navigation device, a global positioning system (GPS) receiver, an event data recorder (EDR), a flight data recorder (FDR), a vehicle infotainment device, an electronic device for a ship, such as a navigation device and a gyro-compass, avionics, security devices, an automotive head unit, a robot for home or industry, an automated teller machine (ATM), a point of sales (POS) device, or Internet of Things devices such as a light bulb, various sensors, electric or gas meter, a sprinkler device, a fire alarm, a thermostat, a streetlamp, a toaster, a sporting goods, a hot water tank, a heater, or a boiler.

The electronic device may also include at least one of a part of furniture or a building/structure, an electronic board, an electronic signature receiving device, a projector, and measuring instruments such as a water meter, an electric meter, a gas meter, and a radio wave meter. In embodiments, the electronic device may be a combination of one or more of the aforementioned various devices, and may also be a flexible device. The electronic device according to an embodiment of the present disclosure is not limited to the aforementioned devices, and may include a new electronic device according to the development of technology.

In the present disclosure, the term “user” may indicate a person using an electronic device or an artificial intelligence electronic device using an electronic device.

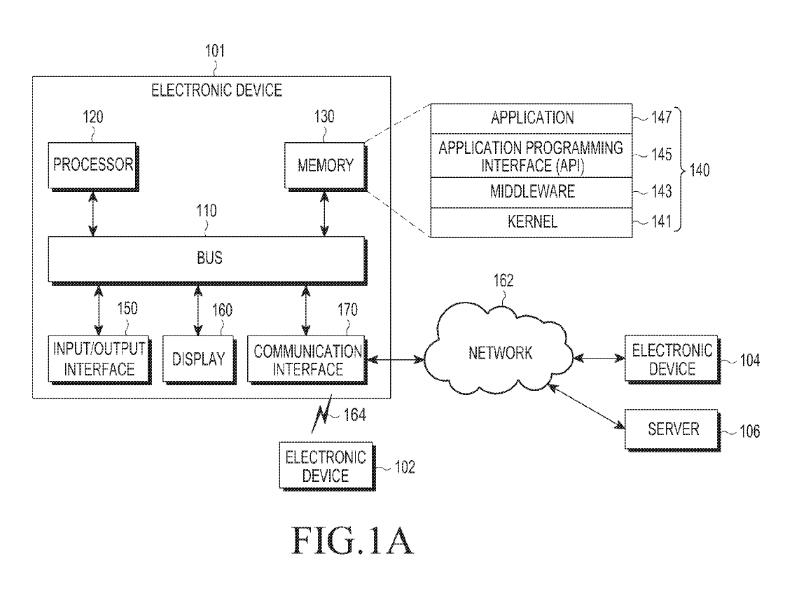

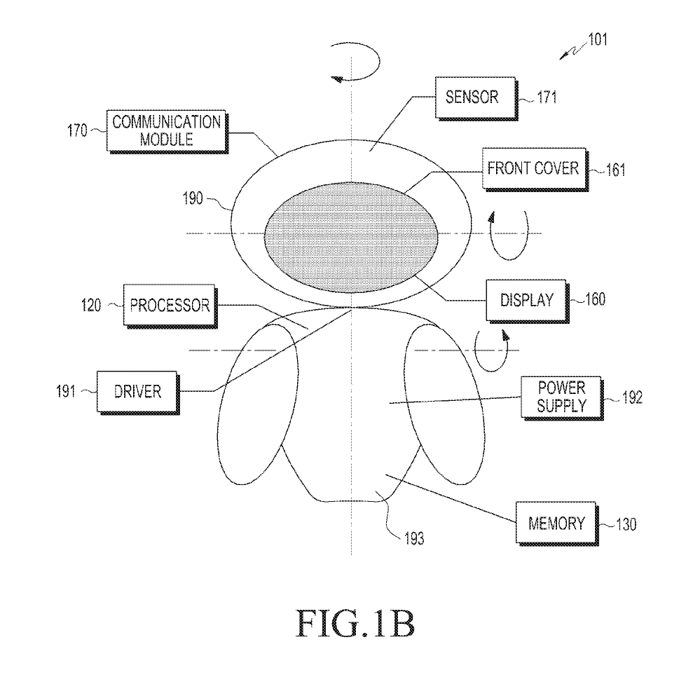

An electronic device 101 within a network environment 100, according to embodiments, will be described with reference to FIG. 1. The electronic device 101 includes a bus 110, a processor 120, a memory 130, an input/output interface 150, a display 160, and a communication interface 170. In some embodiments, the electronic device 101 may omit at least one of the above elements or may further include other elements.

The bus 110 may include a circuit for interconnecting the elements 110 to 170 and transferring communication between the elements.

The processor 120 may include one or more of a central processing unit (CPU), an application processor (AP), a communication processor (CP), a graphic processor (GP), a multi-chip package (MCP), and an image processor (IP). The processor 120 may perform operations or data processing related to control and/or communication of at least one other component of the electronic device 101.

The memory 130 may include a volatile memory and/or a non-volatile memory. The memory 130 stores instructions or data relevant to at least one other element of the electronic device 101. The memory 130 stores software and/or a program 140 including a kernel 141, middleware 143, an application programming interface (API) 145, and/or applications 147. At least two of the kernel 141, the middleware 143, and the API 145 may be referred to as an operating system (OS).

The kernel 141 controls or manages system resources such as the bus 110, the processor 120, or the memory 130, used for performing an operation or function implemented by the other programs such as the middleware 143, the API 145, or the applications 147. Furthermore, the kernel 141 provides an interface through which the middleware 143, the API 145, or the applications 147 accesses the individual elements of the electronic device 101 to control or manage the system resources.

The middleware 143 functions as an intermediary for allowing the API 145 or the applications 147 to communicate with the kernel 141 to exchange data.

In addition, the middleware 143 processes one or more task requests received from the applications 147 according to priorities thereof. For example, the middleware 143 assigns priorities for using the system resources of the electronic device 101, to at least one of the applications 147, and performs scheduling or load balancing on the one or more task requests by processing the one or more task requests according to the priorities assigned thereto.

The API 145 is an interface through which the applications 147 control functions provided from the kernel 141 or the middleware 143, and may include at least one interface or function for file control, window control, image processing, or text control. The input/output interface 150 functions as an interface that transfers instructions or data input from a user or another external device to the other element(s) of the electronic device 101. Furthermore, the input/output interface 150 outputs the instructions or data received from the other element(s) of the electronic device 101 to the user or another external device. The input/output interface 150 may include a touch input device, a voice input unit, and various remote control devices and is at least one means for providing a particular service to the user. For example, the corresponding input/output interface 150 may be a speaker when information to be transferred is a sound, and may be a display device when the information is text or video contents. Further, when the user is away from the electronic device 101, data to be output to provide a service may be transferred and output to one or more other electronic devices through a communication module and, at this time, the other electronic devices may be speakers or other display devices.

The display 160 may include a liquid crystal display (LCD), a light-emitting diode (LED) display, an organic light-emitting diode (OLED) display, a microelectromechanical systems (MEMS) display, and an electronic paper display. The display 160 displays various types of contents for the user, includes a touch screen, and receives a touch, gesture, proximity, or hovering input by using an electronic pen or a part of the user's body.

The communication interface 170 sets communication between the electronic device 101 and an external device such as a first external electronic device 102, a second external electronic device 104, or a server 106. For example, the communication interface 170 may be connected to a network 162 through wireless or wired communication to communicate with the external device. The communication module 170, which corresponds to a means capable of transmitting and receiving one or more pieces of data to and from another electronic device, may communicate with another electronic device through a protocol such as one or more of (communication standard), Wi-Fi, Zigbee, Bluetooth, LTE, 3G, and IR.

The wireless communication may use at least one of long term evolution (LTE), LTE-advanced (LTE-A), code division multiple access (CDMA), wideband CDMA (WCDMA), universal mobile telecommunications system (UMTS), wireless broadband (WiBro), and global system for mobile communications (GSM), as a cellular communication protocol. In addition, the wireless communication may include short range communication 164. The short range communication 164 may include at least one of Wi-Fi, Bluetooth™, near field communication (NFC), and global navigation satellite system (GNSS) or (Glonass). The GNSS may include at least one of a global positioning system (GPS), a Beidou navigation satellite system (hereinafter “Beidou”), and a European global satellite-based navigation system (Galileo), according to a use area, a bandwidth, or the like. Hereinafter, the “GPS” may be used interchangeably with the “GNSS” in the present disclosure. The wired communication may include at least one of a universal serial bus (USB), a high definition multimedia interface (HDMI), recommended standard 232 (RS-232), and a plain old telephone service (POTS). The network 162 may include at least one of a communication network such as a computer network such as a local area network (LAN) or a wide area network (WAN), the Internet, and a telephone network.

Each of the first and second external electronic devices 102 and 104 may be of a type identical to or different from that of the electronic device 101.

The server 106 may include a group of one or more servers.

All or some of the operations performed in the electronic device 101 may be performed in another electronic device or a plurality of 102 and 104 or the server 106. When the electronic device 101 has to perform some functions or services automatically or in response to a request, the electronic device 101 may make a request for performing at least some functions relating thereto to another device instead of performing the functions or services by itself or in addition. Another electronic device may execute the requested functions or the additional functions, and may deliver a result of the execution to the electronic device 101. The electronic device 101 processes the received result as it is or additionally processes the result to provide the requested functions or services. To achieve this cloud computing, distributed computing, or client-server computing technology may be used.

FIG. 1B illustrates an implementation example according to embodiments of the present disclosure.

As illustrated in FIG. 1B, the electronic device 101 may be implemented in a robot type, and may include a head part 190 and a body part 193 arranged below the head part 190. The head part 190 and the body part 193 may be implemented in shapes corresponding to a human's head and body in one embodiment. For example, the head part 190 may include a front cover 161 corresponding to a shape of a human's face. The electronic device 101 may include a display 160 arranged at a location corresponding to the front cover 161. For example, the display 160 may be arranged inside the front cover 161 and, in this case, the front cover 161 may be made of a transparent material or a translucent material. Alternatively, the front cover 161 may be a device that can display a predetermined screen and, in this case, the front cover 161 and the display 160 may be implemented by one hardware. The front cover 161 may be one or more various sensors for sensing an image in a direction of an interaction with the user, one or more microphones for acquiring a voice, a mechanical eye structure, and a display for outputting a screen, may make a display through a light or a temporary mechanical change when there is no direction division, and may include one or more hardware or mechanical structures in a user direction when the interaction with the user is made.

The head part 190 may further include the communication module 170 and a sensor 171. The communication module 170 receives a message from a transmission device and transmit a converted message to a reception device. The communication module 170 may be implemented by a microphone that receives a voice from a user. The communication module 170 may also be implemented by a speaker that outputs a converted message through a voice.

The sensor 171 acquires at least one piece of information on an external environment. For example, the sensor 171 may be implemented by a camera and, in this case, photograph the external environment. The electronic device 101 identifies a receiver according to a result of the photographing. The sensor 171 may sense proximity of the user to the electronic device 101. The sensor 171 may sense the proximity of the receiver according to proximity information or based on a signal from the electronic device used by the receiver. The sensor 171 may sense an action or a location of the user.

A driver 191 may include at least one motor which may cause the head part 190 to move and change a direction of the head part 190. The driver 191 may be used for moving and mechanically changing other elements, and may have a variously implemented shape for up and down or left and right movement based on the center of at least one axis. A power unit 192 may supply power used by the electronic device 101.

The processor 120 acquires a message from a sender through the communication module 170 or the sensor 171 and may include at least one message analysis module. At least one message analysis module extracts main contents to be delivered to the receiver from the message generated by the sender or classify the contents.

The memory 130 is a storage space which may permanently or temporarily store information related to provision of a service to the user, and may exist within the electronic device or in cloud or another server through a network. The memory 130 stores personal information for a user authentication, attribute-related information on a scheme for providing a service to the user, or information for understanding a relationship between various means that may interact with the electronic device 101. The relationship information may be changed through an update or learning according to the use of the electronic device 101 and thus changed. The processor 120 may serve to control the electronic device 101 and provide a service to the user by functionally controlling the sensor 171, the input/output interface 150, the communication module 170, and the memory 130. An information determiner that determines information acquired by the electronic device 101 may be included in at least a part of the processor 120 or the memory 130, and the information determiner extracts at least one piece of data for the service from the information acquired through sensor 171 or the communication module 170.

The implementation of the electronic device 101 in the robot type is only an example and there is no limitation on the implementation type.

According to embodiments of the present disclosure, the memory 130 stores instructions to instruct the processor 120 to perform at least the following:

Acquire an image including a first object, to identify a first part of the first object in the image, identify a second part related to the first part based on a result of the identification of the first part, and perform an operation based on a result of the identification of the second part when the instructions are executed;

Determine an area to be identified corresponding to the first part and identify the second part by identifying an object of the area to be identified when the instructions are executed;

Compare the object of the area to be identified with a pre-stored database and identify the second part based on a result of comparison when the instructions are executed;

Perform an authentication by using the identification result of the first part and perform an operation based on the identification result of the second part and the authentication when the instructions are executed;

Perform an authentication by using the identification result of the first part and the identification result of the second part when the instructions are executed;

Acquire a depth image corresponding to the image and perform segmentation between the first part and the second part in the image based on depth information of the acquired depth image when the instructions are executed;

Acquire additional information related to the image and perform an operation based on the identification result of the second part and the additional information when the instructions are executed. The additional information may include at least one of metadata of the image and information acquired by the electronic device when the image is photographed;

Determine a correlation between the additional information and the identification result of the second part and output information related to the correlation when the instructions are executed;

Determine a size of the first part, determine an area to be identified corresponding to the first part based on the size of the first part, and identify an object in the area to be identified, and to identify the second part when the instructions are executed;

Determine a orientation of the first part, determine an area to be identified corresponding to the first part based on the orientation of the first part, and identify an object in the area to be identified, and to identify the second part when the instructions are executed;

Perform pre-processing including at least one of lighting correction, focus correction, and size adjustment for the image when the instructions are executed;

Acquire an image including a first object, identify a first part of the first object in the image, to identify a second part related to the first part based on an identification result of the first part, and store the identification result of the first part and an identification result of the second part to be associated with each other when the instructions are executed;

Perform an authentication by using at least one of the identification result of the first part and the identification result of the second part and store the identification result of the first part and the identification result of the second part to be associated with a result of the authentication when the instructions are executed;

Acquire additional information related to the image and store the identification result of the first part and the identification result of the second part to be associated with the additional information when the instructions are executed. The additional information may include at least one of metadata of the image and information acquired by the electronic device when the image is photographed;

Acquire a plurality of images including a first object, identify a first part of the first object in each of the plurality of images, identify a second part related to the first part in each of the plurality of images based on an identification result of the first part, and perform an operation based on an identification result of the second part when the instructions are executed;

Perform an operation based on a change in the second part in each of the plurality of images when the instructions are executed;

Acquire additional information corresponding to each of the plurality of images, determine a correlation between the change in the second part in each of the plurality of images and the additional information, and output information related to the correlation when the instructions are executed; and

Acquire an image and to perform an operation related to at least one part of the image based on a type of a first part included in the image when the instructions are executed.

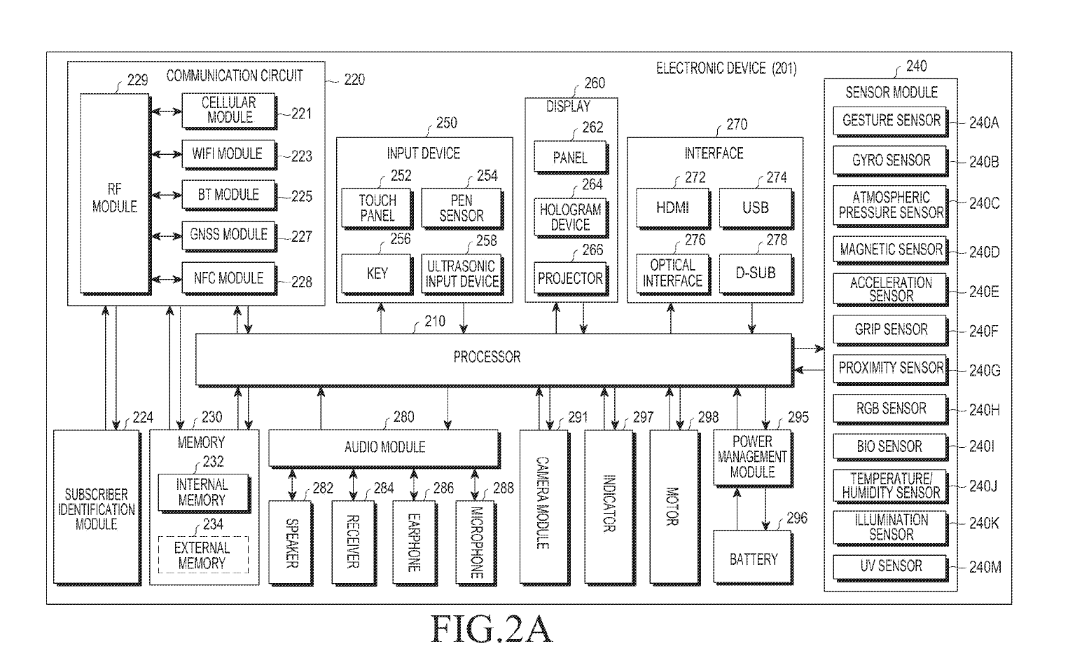

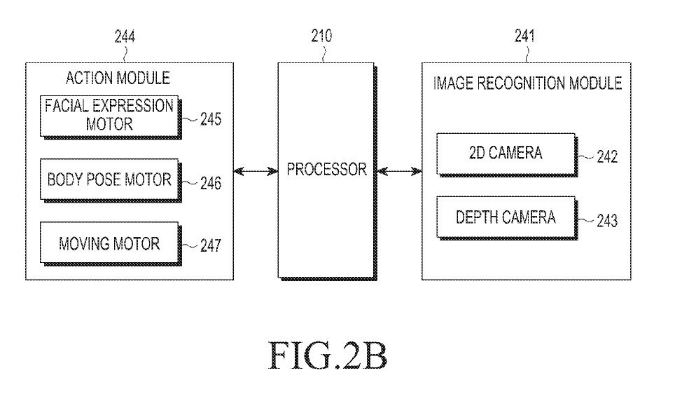

FIG. 2A is a block diagram of an electronic device 201 according to embodiments of the present disclosure. The electronic device 201 includes a processor 210 (for example, an application processor (AP)), a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298.

The processor 210 controls a plurality of hardware or software components connected to the processor 210 by driving an operating system or an application program and performs processing of various pieces of data and calculations. The processor 210 may be implemented by a system on chip (SoC). According to an embodiment, the processor 210 may further include a graphic processing unit (GPU) and/or an image signal processor. The processor 210 may include at least two of the elements illustrated in FIG. 2A. The processor 210 loads, into a volatile memory, instructions or data received from a non-volatile memory of the other elements, processes the loaded instructions or data, and stores various data in a non-volatile memory.

The communication module 220 may include a cellular module 221, a wide fidelity (Wi-Fi) module 223, a Bluetooth™ module 225, a GNSS module 227 (for example, a GPS module, a Glonass module, a Beidou module, or a Galileo module), a near field communication (NFC) module 228, and a radio frequency (RF) module 229.

The cellular module 221 provides a voice call, an image call, a text message service, or an Internet service through a communication network. According to an embodiment, the cellular module 221 identifies and authenticates the electronic device 201 within a communication network using a SIM) card 224. The cellular module 221 performs at least some of the functions that the processor 210 provides, and may include a communication processor (CP).

The Wi-Fi module 223, the Bluetooth module 225, the GNSS module 227, or the NFC module 228 may include a processor that processes data transmitted and received through the corresponding module. According to some embodiments, at least two of the cellular module 221, the Wi-Fi module 223, the BT module 225, the GNSS module 227, and the NFC module 228 may be included in one integrated chip (IC) or IC package.

The RF module 229 transmits/receives a radio frequency (RF) signal. The RF module 229 may include a transceiver, a power amp module (PAM), a frequency filter, a low noise amplifier (LNA), or an antenna. According to another embodiment of the present disclosure, at least one of the cellular module 221, the Wi-Fi module 223, the BT module 225, the GNSS module 227, and the NFC module 228 transmits/receives an RF signal through a separate RF module.

The subscriber identification module 224 may include a card including a subscriber identification module and/or an embedded SIM, and may contain unique identification information such as an integrated circuit card identifier (ICCID) or subscriber information such as an international mobile subscriber identity (IMSI).

The memory 230 may include an internal memory 232 or an external memory 234. The internal memory 232 may include at least one of a volatile memory such as a dynamic random access memory (DRAM), a Static RAM (SRAM), or a synchronous dynamic RAM (SDRAM), and a non-volatile memory such as a one-time programmable read only memory (OTPROM), a programmable ROM (PROM), an erasable and programmable ROM (EPROM), an electrically erasable and programmable ROM (EEPROM), a flash memory such as a NAND or a NOR flash memory, a hard driver, or a solid state drive (SSD).

The external memory 234 may further include a flash drive a compact flash (CF), a secure digital (SD), a micro secure digital (Micro-SD), a mini secure digital (Mini-SD), an extreme digital (xD), multi-media card (MMC), or a memory stick. The external memory 234 may be functionally and/or physically connected to the electronic device 201 through various interfaces.

The sensor module 240 measures a physical quantity or detect an operation state of the electronic device 201, and converts the measured or detected information into an electrical signal. The sensor module 240 may include at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a red, green, blue (RGB) sensor), a biometric sensor 240I, a temperature/humidity sensor 240J, a light sensor 240K, and a ultraviolet (UV) sensor 240M. Additionally or alternatively, the sensor module 240 may include an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors included therein. In some embodiments, an electronic device 201 further includes a processor configured to control the sensor module 240 as a part of or separately from the processor 210, and controls the sensor module 240 while the processor 210 is in a sleep state.

The input device 250 may include a touch panel 252, a (digital) pen sensor 254, a key 256, and an ultrasonic input unit 258. The touch panel 252 may use at least one of a capacitive scheme, a resistive scheme, an infrared scheme, and an ultrasonic scheme. The touch panel 252 may further include a control circuit and a tactile layer that provides a tactile reaction to the user.

The (digital) pen sensor 254 may include a recognition sheet which is a part of the touch panel or is separated from the touch panel. The key 256 may include a physical button, an optical key or a keypad. The ultrasonic input device 258 may detect ultrasonic waves generated by an input tool through a microphone 288 and identify data corresponding to the detected ultrasonic waves.

The display 260 may include a panel 262, a hologram device 264 and a projector 266. The panel 262 may be implemented to be flexible, transparent, or wearable. The panel 262 and the touch panel 252 may be implemented as one module. The hologram 264 displays a three dimensional image in the air by using interference of light. The projector 266 displays an image by projecting light onto a screen. The screen may be located inside or outside of the electronic device 201. According to an exemplary embodiment, the display 260 may further include a control circuit for controlling the panel 262, the hologram device 264, or the projector 266.

The interface 270 may include a high-definition multimedia interface (HDMI) 272, a universal serial bus (USB) 274, an optical interface 276, or a d-subminiature (D-sub) 278. The interface 270 may be included in the communication interface 170 illustrated in FIG. 1. Additionally or alternatively, the interface 270 may include a mobile high-definition link (MHL) interface, an SD card/multi-media card (MMC) interface, or an infrared data association (IrDA) standard interface.

The audio module 280 may bilaterally convert a sound and an electrical signal. The audio module 280 processes sound information which is input or output through a speaker 282, a receiver 284, earphones 286, or the microphone 288.

The camera module 291 photographs a still image and a dynamic image. According to an embodiment, the camera module 291 may include one or more image sensors such as a front or a back sensor, a lens, an image signal processor (ISP) or a flash such as a light emitting diode (LED) or xenon lamp.

The power management module 295 manages power of the electronic device 201. According to an embodiment, the power management module 295 may include a power management integrated circuit (PMIC), a charger integrated circuit (IC), or a battery gauge. The PMIC may use a wired and/or wireless charging method. Examples of the wireless charging method may include a magnetic resonance method, a magnetic induction method, and an electromagnetic method. Additional circuits such as a coil loop, a resonance circuit, or a rectifier, for wireless charging may be further included. The battery gauge measures a residual quantity of the battery 296, and a voltage, a current, or a temperature during the charging. The battery 296 may include a rechargeable battery or a solar battery.

The indicator 297 may indicate a booting, message, or charging state of the electronic device 201 or a part (for example, the processor 210) of the electronic device 201. The motor 298 converts an electrical signal into mechanical vibration, and generates vibration or a haptic effect. Although not illustrated, the electronic device 201 may include a graphic processing unit (GPU) for supporting mobile television (TV). The GPU for supporting mobile TV may process media data according to a certain standard such as digital multimedia broadcasting (DMB), digital video broadcasting (DVB), or Mediaflo™.

Each of the above-described component elements of hardware according to the present disclosure may be configured with one or more components, and the names of the corresponding component elements may vary based on the type of electronic device. The electronic device according to embodiments of the present disclosure may include at least one of the aforementioned elements. Some elements may be omitted or other additional elements may be further included in the electronic device. Also, some of the hardware components according to embodiments may be combined into one entity, which performs functions identical to those of the relevant components before the combination.

FIG. 2B is a block diagram of an electronic device according to embodiments of the present disclosure. As illustrated in FIG. 2B, the processor 210 may be connected to an image recognition module 241. The processor may be connected to an action module 244. The image recognition module 241 may include at least one of a two dimensional (2D) camera 242 and a depth camera 243. The image recognition module 241 performs recognition based on a photographing result and transfer a recognition result to the processor 210. The action module 244 may include at least one of a facial expression motor 245, a body pose motor 245, and a movement motor 247. The processor 210 controls movement of the electronic device 101 implemented in a robot type by controlling at least one of the facial expression motor 245, the body pose motor 246, and the movement motor 247. The electronic device 101 may include elements of FIG. 2B in addition to the elements of FIG. 2A.

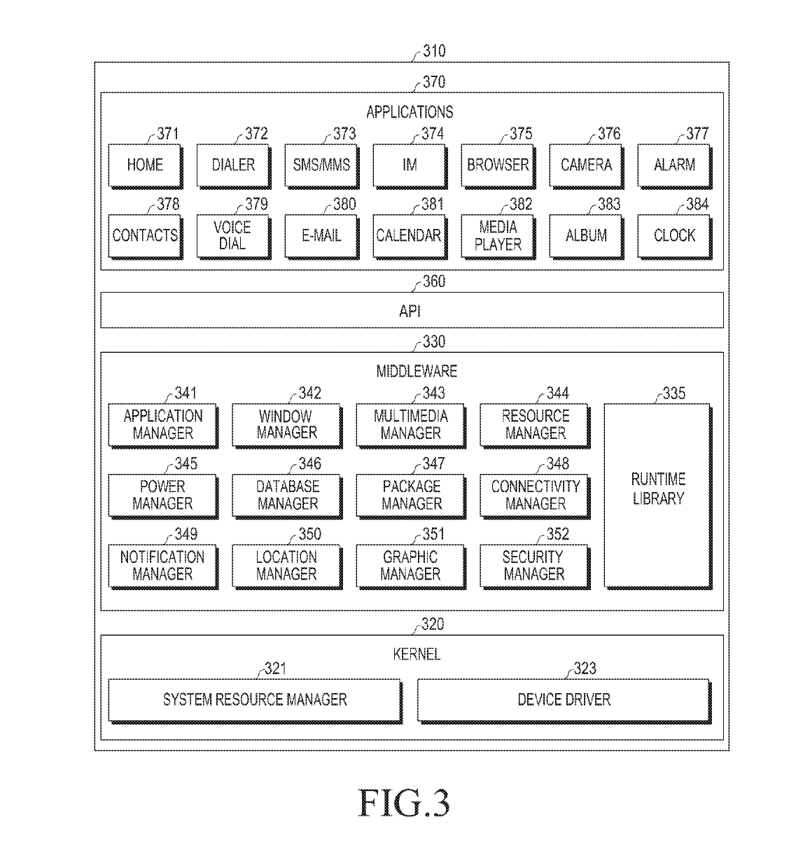

FIG. 3 is a block diagram of a program module according to embodiments of the present disclosure. According to an embodiment, the program module 310 may include an OS for controlling resources related to the electronic device 101 and/or various applications 147 executed in the operating system. The operating system may be Android, iOS, Windows, Symbian, Tizen, Bada, or the like.

The program module 310 may include a kernel 320, middleware 330, an application programming interface (API) 360, and/or applications 370. At least a part of the program module 310 may be preloaded on the electronic device, or may be downloaded from an external electronic device 102 or 104, or the server 106.

The kernel 320 may include a system resource manager 321 and/or a device driver 323. The system resource manager 321 controls, assigns, or collects system resources. According to an embodiment, the system resource manager 321 may include a process manager, a memory manager, or a file system manager. The device driver 323 may include a display driver, a camera driver, a Bluetooth driver, a shared memory driver, a universal serial bus (USB) driver, a keypad driver, a Wi-Fi driver, an audio driver, or an inter-process communication (IPC) driver.

The middleware 330 provides a function required by the applications 370 in common or provides various functions to the applications 370 through the API 360 so that the applications 370 can efficiently use limited system resources within the electronic device. The middleware 330 includes a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add new functions through a programming language while the applications 370 are executed. The runtime library 335 performs input/output management, memory management, or a function for an arithmetic function.

The application manager 341 may manage a life cycle of at least one of the applications 370. The window manager 342 manages graphical user interface (GUI) resources used on a screen. The multimedia manager 343 identifies formats required for the reproduction of various media files and encodes or decodes a media file using a codec suitable for the corresponding format. The resource manager 344 manages resources of at least one of the applications 370, such as a source code, a memory, and a storage space.

The power manager 345 may operate together with a basic input/output system (BIOS) to manage a battery or power and provides power information required for the operation of the electronic device. The database manager 346 generates, searches for, and/or changes a database to be used by at least one of the applications 370. The package manager 347 manages the installation or the updating of an application distributed in the form of a package file.

The connectivity manager 348 manages a wireless connection such as Wi-Fi or Bluetooth. The notification manager 349 displays or notify an event, such as an arrival message, an appointment, proximity notification, and the like, in a manner that does not disturb a user. The location manager 350 manages location information of the electronic device. The graphic manager 351 manages a graphic effect to be provided to a user and a user interface relating to the graphic effect. The security manager 352 provides all security functions required for system security or user authentication. According to an embodiment, when the electronic device 101 has a telephone call function, the middleware 330 may further include a telephony manager for managing a voice call function or a video call function of the electronic device.

The middleware 330 may include a middleware module that forms combinations of various functions of the above described elements. The middleware 330 provides modules specialized according to types of operating systems in order to provide differentiated functions. Furthermore, the middleware 330 may dynamically remove some of the existing elements, or may add new elements.

The API 360 is a set of API programming functions, and may be provided with a different configuration according to an OS. For example, in the case of Android or iOS, one API set may be provided for each platform, and in the case of Tizen, two or more API sets may be provided for each platform.

The applications 370 include one or more applications that can perform functions, such as home 371, dialer 372, short messaging service/multimedia messaging service (SMS/MMS) 373, instant message (IM) 374, browser 375, camera 376, alarm. 377, contacts 378, voice dial 379, e-mail 380, calendar 381, media player 382, album 383, clock 384, health care (for example, measure exercise quantity or blood sugar), or environment information (for example, atmospheric pressure, humidity, or temperature information.

According to an embodiment, the applications 370 may include a supporting information exchange between the electronic device 101 and an external electronic device 102 or 104. The information exchange application may include a notification relay application for transferring specific information to an external electronic device or a device management application for managing an external electronic device.

For example, the notification relay application may include a function of transferring, to the external electronic device 102 or 104, notification information generated from other applications of the electronic device 101. The notification relay application receives notification information from an external electronic device and provide the received notification information to a user.

The device management application installs, deletes, or updates at least one function of an external electronic device 102 or 104 communicating with the electronic device (for example, a function of turning on/off the external electronic device itself (or some components) or a function of adjusting luminance (or a resolution) of the display), applications operating in the external electronic device, or services provided by the external electronic device (for example, a call service and a message service).

The applications 370 may include a health care application of a mobile medical appliance, designated according to attributes of the external electronic device 102 or 104. The applications 370 may include an application received from the external electronic device, and may include a preloaded application or a third party application which can be downloaded from the server. Names of the elements of the program module 310, according to the above-described embodiments of the present disclosure, may change depending on the type of OS.

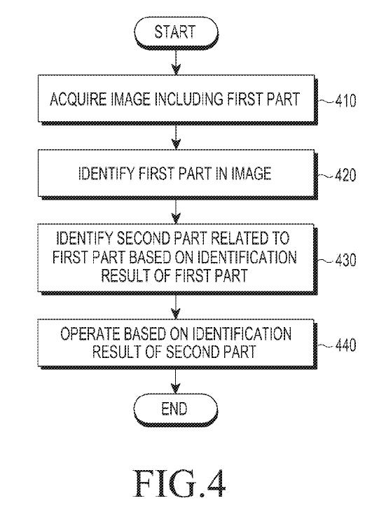

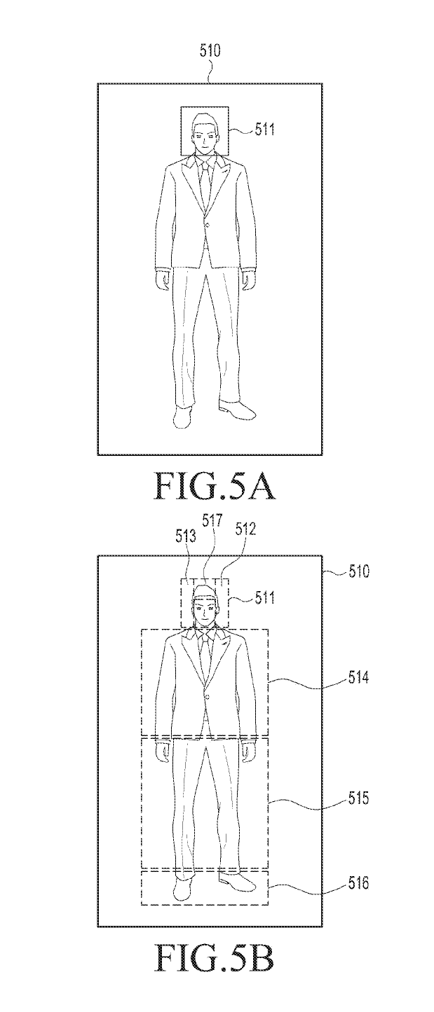

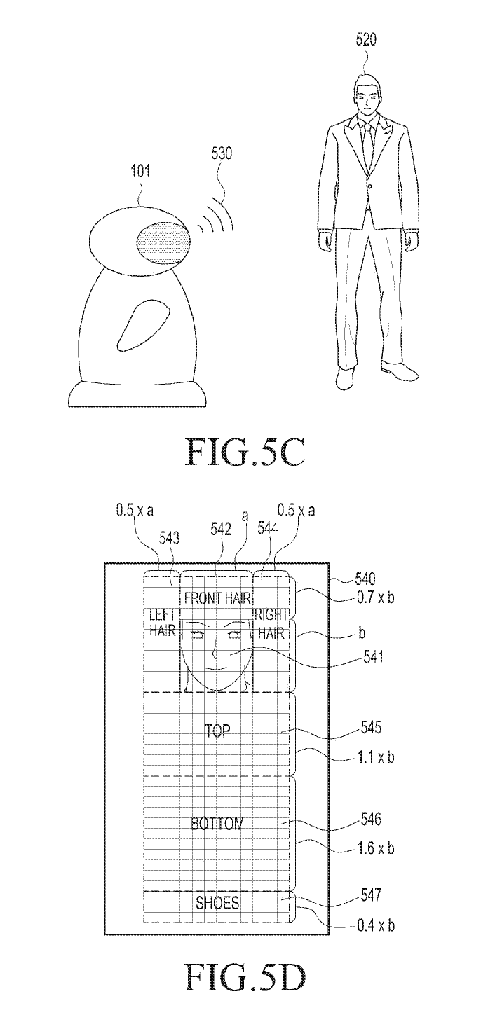

FIG. 4 illustrates a method of controlling an electronic device according to embodiments of the present disclosure. The embodiment of FIG. 4 will be described in more detail with reference to FIGS. 5A, 5B, 5C and 5D. FIGS. 5A and 5B illustrate an acquired image according to embodiments of the present disclosure. FIG. 5C illustrates the electronic device according to embodiments of the present disclosure. FIG. 5D illustrates an area to be identified according to embodiments of the present disclosure.

In step 410 of FIG. 4, the electronic device 101 acquires an image including a first object and the first object may include a first part. The part may refer to some of the first object or the first object itself. For example, when the first object is a human body, the human body object may have various elements such as a face, hair, an upper body, and a lower body, and each of the various elements of the object may be referred to as the part. According to embodiments of the present disclosure, the electronic device 101 may include a camera module and acquire an image through the camera module arranged on a front surface part to photograph the front surface of the electronic device 101, or arranged on a rear surface to photograph the rear surface of the electronic device 101.

There is no limitation on the type of camera module and the number of camera modules. For example, the electronic device 101 may include two or more camera modules on the rear surface or the front surface, and generate an image by using data photographed through the two or more camera modules to acquire the image. When the electronic device 101 is implemented in a type such as a robot, the electronic device 101 acquires an image through the sensor 171.

The electronic device 101 receives an image from another electronic device through the communication module 170. For example, the electronic device 101 receives the image through short range communication with another electronic device or receive an image from another mobile terminal or a server through wireless communication by using web browsing. Alternatively, the processor 120 of the electronic device 101 loads an image stored in the memory 130 to acquire the image.

For example, as illustrated in FIG. 5A, the electronic device 101 acquires an image 510 including a first part 511 corresponding to a person's face.

In step 420, the electronic device 101 identifies the first part 511 in the image. According to embodiments of the present disclosure, the electronic device 101 stores an object recognition algorithm for various objects such as a person and a tree, and identifies the first part 511 by applying the object recognition algorithm to the acquired image, and stores various object recognition algorithms. It will be easily understood by those skilled in the art that there is no limitation on the object recognition algorithm. In the embodiment of FIG. 5A, the electronic device 101 identifies the first part 511 corresponding to a face part by applying a face recognition algorithm to the image 510.

In step 430, the electronic device 101 identifies a second part related to the first part based on a result of the identification of the first part, based on the type of first part. For example, in the embodiment of FIG. 5B, the electronic device 101 identifies the second part such as right hair 512, left hair 513, top 514, bottom 515, shoes 516, and front hair 517 related to the first part 511 based on the face part which is the type of first part 511. More particularly, the electronic device 101 identifies an area to be identified, related to the first part based on the fact that the type of first part is the face. The area to be identified may be set on a predetermined location based on the identified first part and may be differently set according to the type of first part. For example, the electronic device 101 presets a hair-related area adjacent to an upper side and left and right sides of the face part, a top-related area adjacent to a lower side of the face part, a bottom-related area adjacent to a lower side of the top-related area, and a shoe-related area adjacent to a lower side of the bottom-related area as the areas to be identified in accordance with the face part. The areas to be identified will be described in more detail with reference to FIG. 5D. The electronic device 101 identifies the second part by identifying a part arranged in the area to be identified of the image. An operation amount and time required for identifying the second part may be rapidly reduced by identifying only a preset area according to the first part without identifying all parts within the image.

In FIG. 5B, the electronic device 101 acquires an identification result of the second part indicating that there is no right hair 512 or left hair 513, the front hair 517 is short to expose the forehead, the top 514 corresponds to long sleeves, the bottom 515 corresponds to long pants, and the shoes 516 correspond to dress shoes. The electronic device 101 acquires the identification result of the second part by comparing the object of the area to be identified with a template according to each of pre-stored areas to be identified. For example, the electronic device 101 stores various templates such as long sleeves, short sleeves, t-shirt, shirt, and coat in accordance with areas to be identified, located below the face part. The electronic device 101 compares the lower portion 514 of the first part 511 with the stored template, and acquires a recognition result of the second part based on a comparison result. The electronic device 101 acquires a template having a highest similarity as the recognition result of the second part. The storage of the templates by the electronic device 101 according to each of the areas to be identified is only an example, and the electronic device 101 transmits a query including an image of the area to be identified to a server that manages an external database and receive a recognition result thereof, thereby acquiring the recognition result of the second part.

The electronic device 101 or the server may update or add a template of the second part by using a learning algorithm.

In step 440, the electronic device 101 performs an operation based on an identification result of the second part. For example, as illustrated in FIG. 5C, the electronic device 101 outputs a voice message 530 that reflects the identification result of the second part to a user 520. For example, the electronic device 101 outputs the voice message including a sentence such as “James is wearing long sleeves today”. The electronic device 101 outputs information including the identification result of the second part and there is no limitation on an output scheme thereof. As illustrated in FIG. 5C, when the electronic device 101 is implemented in a robot type, the robot outputs the voice message 530 to the user 520 nearby, and the user 520 acquires feedback.

FIG. 5D illustrates an area to be identified according to embodiments of the present disclosure.

The electronic device 101 presets areas 542 to 547 to be identified, corresponding to a first part 541 in an image 540. Each of position of the areas 542 to 547 is preset according to a position of the first part 541. The areas 542 to 547 to be identified of FIG. 5D are illustrated merely for convenience of description, and the electronic device 101 presets areas to be identified as shown in Table 1. The electronic device 101 sets a first part having horizontal a pixels and vertical b pixels. a and b may be parameters for comparing the relative size of the first part to determine the size of the area to be identified.

TABLE 1

| Area to be | |
|---|---|
| identified | Location information |
| Front hair | a pixels and 0.7 × b pixels in upper side of face part |
| Left hair | 0.5 × a pixels and 1.7 × b pixels in left side of face part |
| Right hair | 0.5 × a pixels and 1.7 × b pixels in right side of face part |
| Top | 2 × a pixels and 1.1 × b pixels in lower side of face part |
| Bottom | 2 × a pixels and 1.6 × b pixels in lower side of top part |
| Shoes | 2 × a pixels and 0.4 × b pixels in lower side of bottom part |

The electronic device 101 sets the area to be identified, according to each type of the first part to be first identified. For example, the electronic device 101 sets the area to be identified as illustrated in Table 1 with respect to the face part, but sets the area to be identified, which is different from Table 1, with respect to other types of parts. As described above, the electronic device 101 stores a template in accordance with each of the areas to be identified, and identifies a second part based on a template comparison result. For example, the electronic device 101 stores various front hair shape templates corresponding to areas to be identified of the front hair, and identifies a template which is the most similar with an object of the area to be identified of the front hair within the image as the second part. As the electronic device 101 limits the part to be compared as the object within the area to be identified, an operation amount and time required for the comparison and the identification may be reduced.

The electronic device 101 determines the area to be identified based on depth information. More specifically, the electronic device 101 determines the depth information and determines the area to be identified according to an area having a depth value which is different from the first part by a preset threshold value or less.

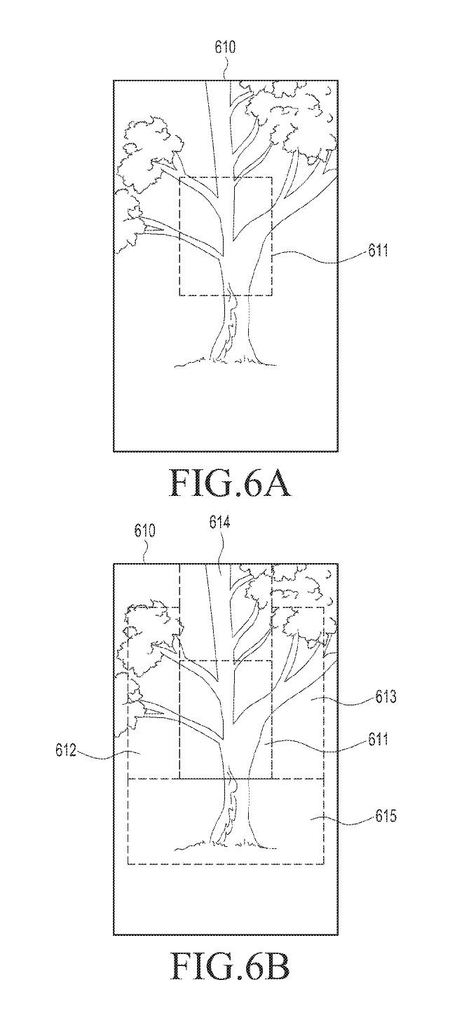

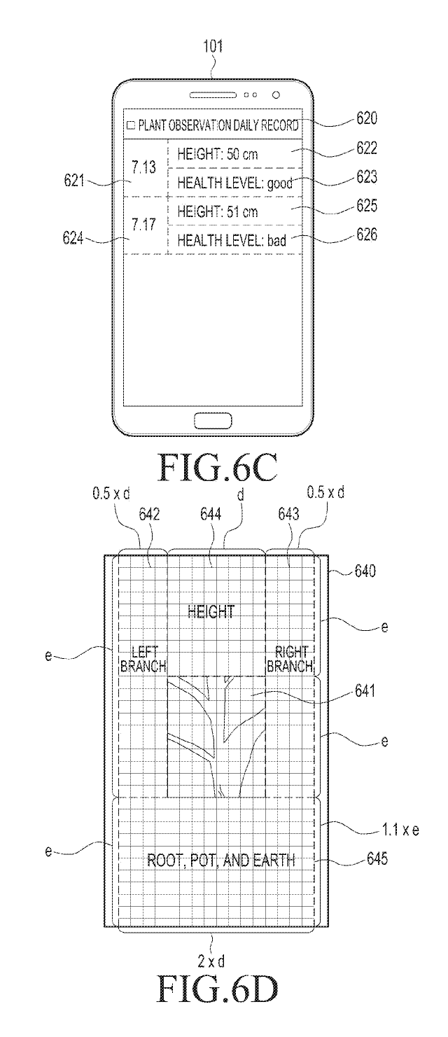

FIGS. 6A, 6B, 6C and 6D illustrate a processing process related to different types of first parts according to embodiments of the present disclosure.

As illustrated in FIG. 6A, the electronic device 101 acquires an image 610 including a first part 611 corresponding to the main stem of a plant.

The electronic device 101 identifies the first part 611 in the image. The electronic device 101 stores an object recognition algorithm for various objects such as a person and a tree, and identifies the first part 611 by applying the object recognition algorithm to the acquired image. In the embodiment of FIG. 6A, the electronic device 101 identifies the first part 611 corresponding to the main stem part by applying a plant recognition algorithm to the image 610.

The electronic device 101 identifies second parts 612, 613, 614 and 615 related to the first part 611 based on an identification result of the first part 611. According to embodiments of the present disclosure, the electronic device 101 identifies the second parts 612, 613, 614 and 615 related to the first part 611 based on a type of the first part 611. For example, in the embodiment of FIG. 6B, the electronic device 101 identifies the second part such as a left branch 612, a right branch 613, the height of a tree 614, and root, pot, and earth 615, related to the first part 611 based on the main stem part which is the type of the first part 611.

More particularly, the electronic device 101 identifies an area to be identified, related to the first part 611 based on the fact that the type of the first part 611 is the main stem. The electronic device 101 sets a height-related area adjacent to an upper portion of the main stem part, a branch-related area adjacent to a left/right portion of the main stem part, and an earth-related area adjacent to a lower portion of the main stem part as the areas to be identified. The areas to be identified will be described in more detail with reference to FIG. 6D. The electronic device 101 identifies the second part by identifying an object arranged in the area to be identified of the image. The amount of operations and time required for identifying the second part may be rapidly reduced by identifying only a preset area according to the first part without identifying all objects within the image.

In FIG. 6B, the electronic device 101 acquires an identification result of the second part including health states of the left branch 612 and the right branch 613, information on the height 614, and the shape of the pot 615, such as by comparing the object of the area to be identified with a template according to each of pre-stored areas to be identified. For example, the electronic device 101 stores various templates such as earth, pot shape, and root shape in accordance with the areas to be identified, located at the lower portion of the main stem part. The electronic device 101 compares the lower portion 615 of the first part 611 with the stored template, and acquires a recognition result of the second part based on a comparison result. For example, the electronic device 101 acquires a template which is the most similar as the recognition result of the second part. The storage of the templates by the electronic device 101 according to each of the areas to be identified is only an example, and the electronic device 101 transmits a query including an image of the area to be identified to a server that manages an external database and receive a recognition result thereof, thereby acquiring the recognition result of the second part. The electronic device 101 or the server may update or add a template of the second part by using a learning algorithm.

The electronic device 101 performs an operation based on the identification result of the second part. For example, the electronic device 101 provides a graphic user interface 620 of a plant observation daily record as illustrated in FIG. 6C. According to embodiments of the present disclosure, the graphic user interface 620 of the plant observation daily record may include height information 622 and 625 and health information 623 and 626 on dates 621 and 624.

The electronic device 101 determines a change in the second part. As described above, the electronic device 101 stores information on the second part according to time and, accordingly, determines a change in at least some of the second part. The electronic device 101 performs an operation corresponding to the change in the second part. For example, when discoloration of leaves is detected, the electronic device 101 outputs a message to provide water or nourishment.

FIG. 6D illustrates an area to be identified according to embodiments of the present disclosure.

The electronic device 101 presets areas 642 to 645 to be identified, corresponding to the first part 641 in an image 640. Each of position of the areas 642 to 645 is preset according to a position of the first part 641. The areas 642 to 645 to be identified of FIG. 6D are illustrated merely for convenience of description, and the electronic device 101 may preset areas to be identified as shown in Table 2. The electronic device 101 sets the first part having horizontal d pixels and vertical e pixels. d and e may be parameters for comparing the relative size with the first part to determine the size of the area to be identified.

TABLE 2

| Area to be | |
|---|---|
| identified | Location information |
| Left branch | 0.5 × d pixels and 1.7 × e pixels in left side |
| | of main stem part |
| Right branch | 0.5 × d pixels and 1.7 × e pixels in right side of main |
| | stem part |
| Height | d pixels and e pixels in upper side of main stem part |
| Earth | 2 × d pixels and 1.1 × e pixels in lower side of main |
| | stem part |

The electronic device 101 sets the area to be identified, according to each type of the first part to be first identified. For example, the electronic device 101 sets the areas to be identified as illustrated in Table 2 with respect to the main stem part, which may be different from the areas to be identified, illustrated in FIG. 1. As described above, the electronic device 101 stores the template in accordance with each of the areas to be identified, and identifies the second part based on a template comparison result. For example, the electronic device 101 stores various shape templates corresponding to areas to be identified in the earth, and identifies a template which is the most similar with an object of the area to be identified in the earth within the image as the second part.

The electronic device 101 determines the area to be identified based on depth information. More specifically, the electronic device 101 determines depth information and determines the area to be identified according to an area having a depth value which is different from the first part by a preset threshold or less.

As described above with reference to FIGS. 5A, 5B, 5C and 5D and FIGS. 6A, 6B, 6C and 6D, the electronic device 101 sets different areas to be identified according to the type of the first part. Accordingly, the electronic device 101 identifies the second part by using an identification result of the first part. The electronic device 101 performs an operation related to at least one area of the image based on the type of the identified part.

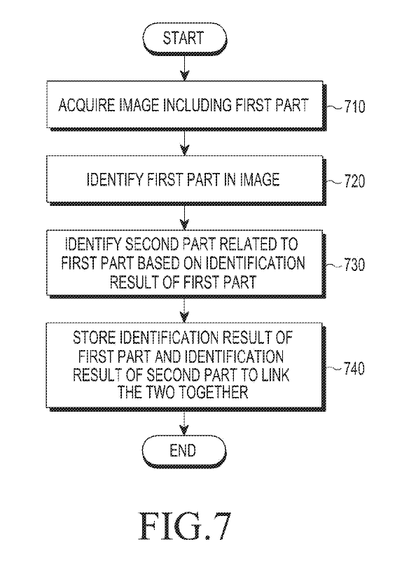

FIG. 7 illustrates a control method of the electronic device according to embodiments of the present disclosure.

In step 710, the electronic device 101 acquires an image including a first part, through various hardware such as a camera module or a communication module.

In step 720, the electronic device 101 identifies the first part in the image. As described above, the electronic device 101 stores various object recognition algorithms, and identifies the first part by applying the object recognition algorithm to the acquired image.

In step 730, the electronic device 101 identifies a second part related to the first part based on a result of the identification of the first part. As described above, the electronic device 101 determines an area to be identified in the image, based on the identification result of the first part. The electronic device 101 compares an object of the area to be identified within the image with a pre-stored template according to each area to be identified. The electronic device 101 determines a template which is the most similar as an identification result of the second part.

In step 740, the electronic device 101 stores the identification result of the first part and the identification result of the second part such that the results are associated with each other.

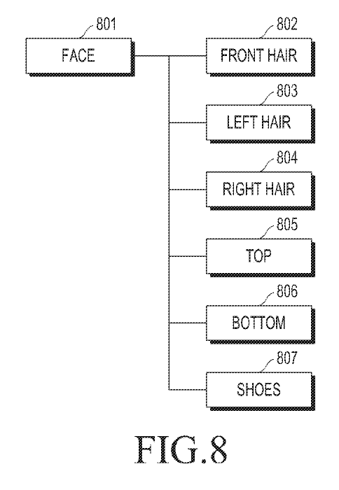

FIG. 8 illustrates a data structure of the stored identification result according to embodiments of the present disclosure. The electronic device 101 according to embodiments of the present disclosure stores a first part 801 and identified second parts 802 to 807 such that the parts are be associated with each other as illustrated in FIG. 8. The electronic device 101 stores identification results of the second parts 802 to 807 including identification results of front hair 802, left hair 803, right hair 804, top 805, bottom 806, and shoes 807 in accordance with the first part 801 of a face part. According to the embodiment of FIG. 8, although the data structure is illustrated as being hierarchical, it is only an example, and the first part 801 and the second parts 802 to 807 may be stored as the same layer. The electronic device 101 may chronologically store and manage the data structure illustrated in FIG. 8 or update and manage the data structure. Alternatively, the electronic device 101 may add a new object to the template and output information related thereto.

The electronic device 101 stores the identification result of the first part and the identification result of the second part or transmits the identification results to another electronic device. Alternatively, the electronic device 101 may chronologically store and manage the identification result of the first part and the identification result of the second part according to an order of dates. The electronic device 101 may operate based on the identification result of the first part and the identification result of the second part, which have been chronologically stored. For example, the electronic device 101 may operate based on a change in at least some of the second part, which will be described below in more detail.

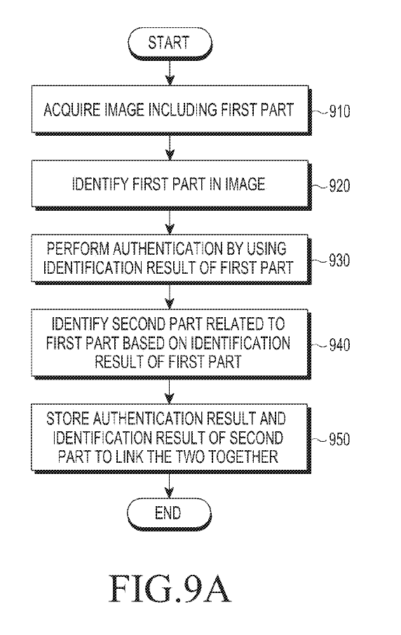

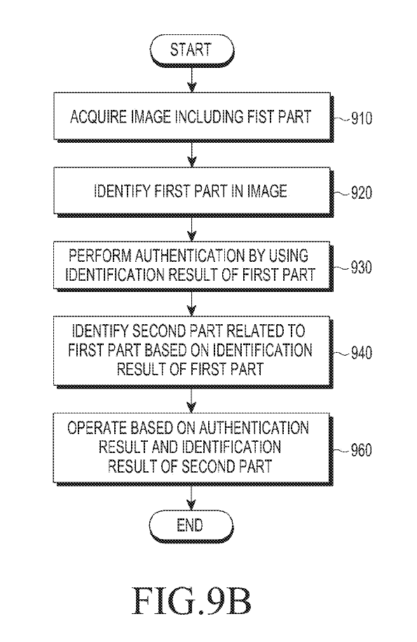

FIGS. 9A and 9B illustrate a control method of the electronic device according to embodiments of the present disclosure.

Referring first to FIG. 9A, in step 910, the electronic device 101 acquires an image including a first part. As described above, the electronic device 101 acquires the image through various hardware such as a camera module or a communication module.

In step 920, the electronic device 101 identifies the first part in the image. As described above, the electronic device 101 stores various object recognition algorithms, and identifies the first part by applying the object recognition algorithm to the acquired image.

In step 930, the electronic device 101 performs an authentication by using an identification result of the first part. For example, the electronic device 101 may recognize a face part from the image and perform an authentication based on an identification result of the face part. That is, the electronic device 101 may authenticate a target to be image-photographed as a first user.

In step 940, the electronic device 101 identifies a second part related to the first part based on the identification result of the first part. As described above, the electronic device 101 determines an area to be identified in the image, based on the identification result of the first part. The electronic device 101 compares an object of the area to be identified within the image with a pre-stored template according to each area to be identified. The electronic device 101 determines a template which is most similar as an identification result of the second part.

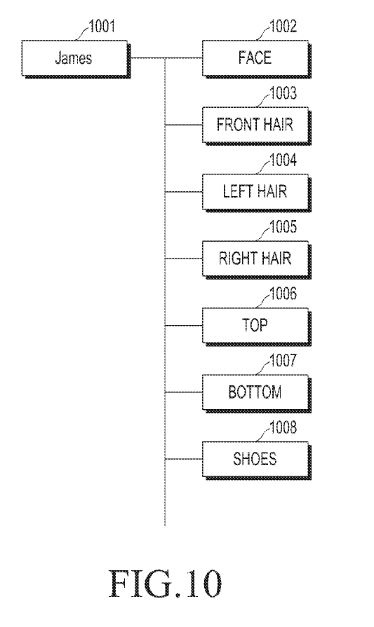

In step 950, the electronic device 101 stores the authentication result and the identification result of the second part such that the results are associated with each other. Alternatively, the electronic device 101 stores the authentication result and the identification results of the first part and the second part such that the identification results are associated with each other. For example, the electronic device 101 stores an authentication result 1001 to be associated with an identification result 1002 of the first part and identification results 1003 to 1008 of the second part as illustrated in FIG. 10. According to an embodiment of FIG. 10, although the data structure is illustrated as being hierarchical, it is only an example, and the authentication results 1001 may be stored as the same layer as that of the identification result 1002 of the first part and the identification results 1003 to 1008 of the second parts. The electronic device 101 may chronologically store and manage the data structure illustrated in FIG. 10 or update and manage the data structure.

Referring to FIG. 9B, in step 910, the electronic device 101 acquires an image including a first part. In step 920, the electronic device 101 identifies the first part in the image. As described above, the electronic device 101 stores various object recognition algorithms, and identifies the first part by applying the object recognition algorithm to the acquired image. In step 930, the electronic device 101 performs an authentication by using an identification result of the first part. For example, the electronic device 101 may recognize a face part from the image and perform an authentication based on an identification result of the first part. In step 940, the electronic device 101 identifies a second part related to the first part based on a result of the identification of the first part.

In step 960, the electronic device 101 may operate based on the authentication result and the identification result of the second part. For example, the electronic device 101 determines that a target to be photographed corresponds to James based on the authentication result and determines that the top corresponds to long sleeves based on the identification result of the second part. The electronic device 101 displays a sentence “James is wearing long sleeves today” or output a voice through TTS based on the identification result and the identification result of the second part.

When there is no change in at least some of the second part, the electronic device 101 may operate in accordance with no change. For example, when shoes of a particular user do not change for a long time, the electronic device 101 outputs a message that proposes a change to other shoes.

According to embodiments of the present disclosure, the electronic device 101 may reflect a relationship between the authentication result and a sender, a receiver, or the electronic device in the output message.

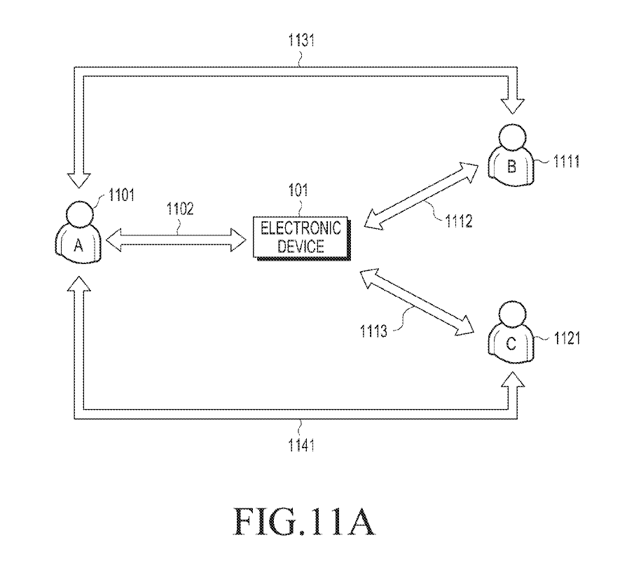

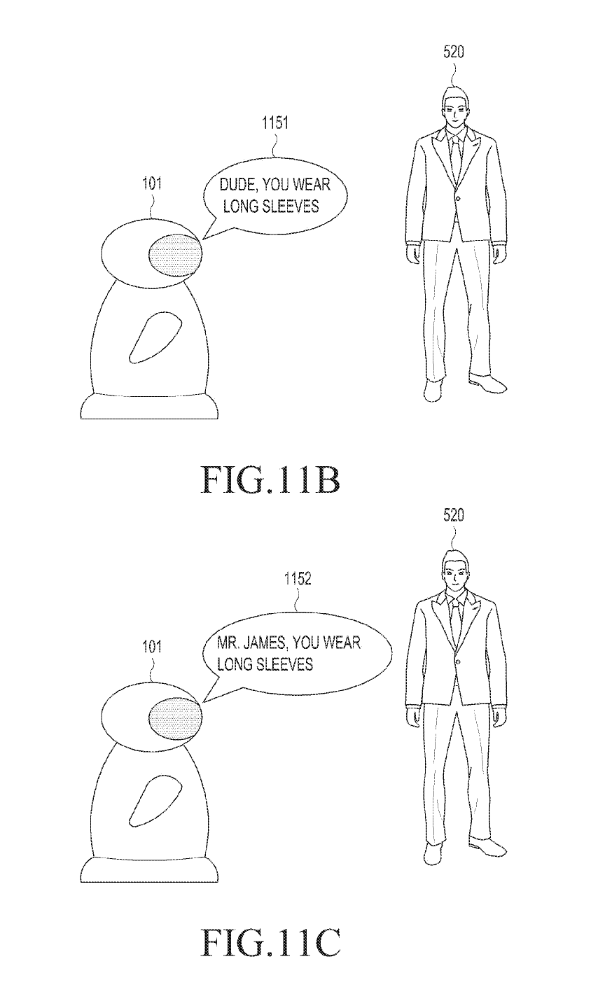

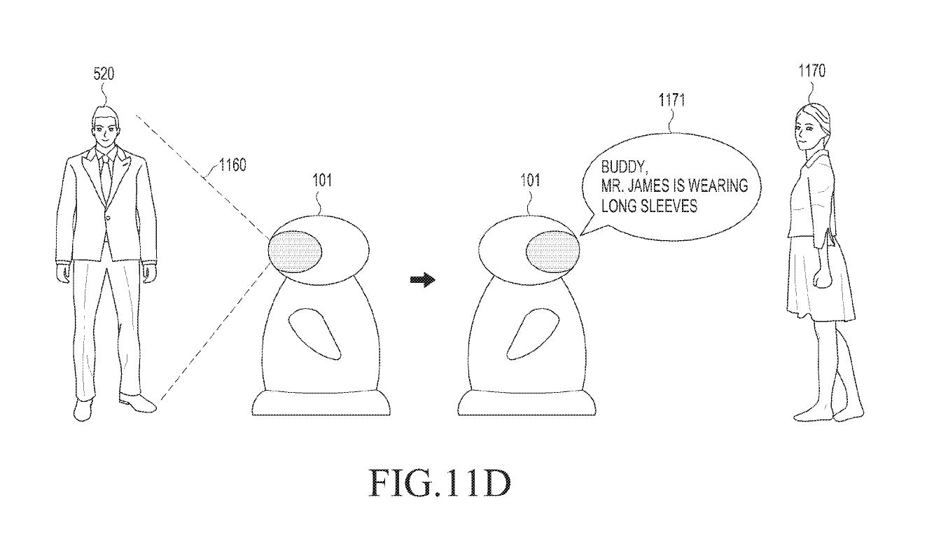

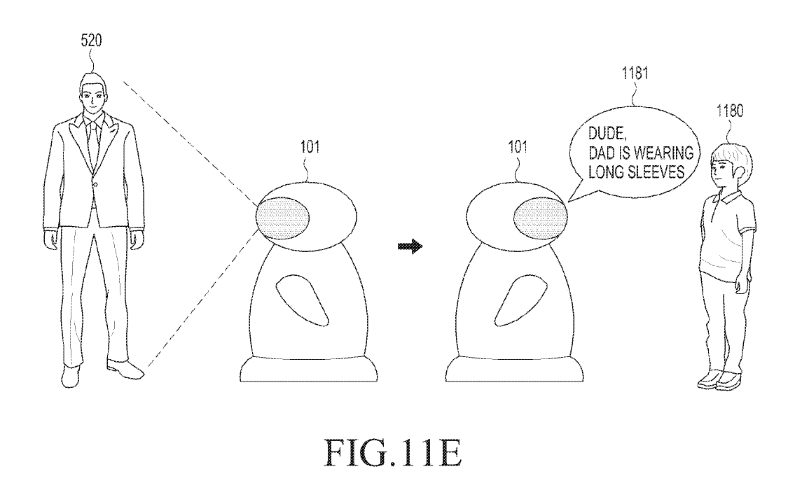

FIGS. 11A, 11B, 11C, 11D and 11E illustrate an output message converting process according to embodiments of the present disclosure.

As illustrated in FIG. 11A, the electronic device 101 determines target A 1101 to be authenticated. The electronic device 101 determines that one or more receivers 1111 and 1121 to which an authentication result and an identification result of the second part will be output. The electronic device 101 transfers an output message to at least one of the first receiver B 1111 and the second receiver C 1121. The electronic device 101 transmits the output message to a first reception device used by the first receiver B 1111 and transmits the output message to a second reception device used by the second receiver C 1121. In this case, the electronic device 101 transmits the output message to the reception device according to various communication schemes. The electronic device 101 transmits messages 412 and 422 by using a message transmission/reception application. The electronic device 101 outputs the output message to at least one of the first receiver B 1111 and the second receiver C 1121 through a voice. For example, the electronic device 101 combines contents of the message with a voice and output the output message through the voice. There is no limitation on combining the contents of the message with the voice by the electronic device 101. The target A to be authenticated may be the same or different from the receiver.

The electronic device 101 converts the output message and provides the converted output message. That is, the electronic device 101 generates the output message by using the authentication result and the identification result of the second part, and then converts and outputs the generated output message.

The electronic device 101 identifies first relationship information 1131 between the target A 1101 to be authenticated and the first receiver B 1111. The electronic device 101 identifies second relationship information 1141 between the target A 1101 to be authenticated and the second receiver C 1121. The electronic device 101 identifies a third relationship 1102 between the target A 1101 to be authenticated and the electronic device 101, a fourth relationship 1112 between the electronic device 101 and the first receiver B 1111, and a fifth relationship 1113 between the electronic device 101 and the second receiver C 1112.

The electronic device 101 presets and stores at least one of the first relationship 1131 to the fifth relationship 1113 or set at least one of the first relationship 1131 to the fifth relationship 1113 at an output time point of the output message. For example, the electronic device 101 determines a receiver to receive the output message and acquires relationship information corresponding to the determined receiver.

When the electronic device 101 transfers the output message to the first receiver B 1111, the electronic device 101 converts the output message based on at least one of the first relationship information 1131, the third relationship information 1102, and the fourth relationship information 1112. When the electronic device 101 transfers the output message to the second receiver C 1121, the electronic device 101 converts the output message based on at least one of the second relationship information 1141, the third relationship information 1102, and the fifth relationship information 1113. The converted message may be converted according to different conditions according to receivers, and the converted messages according to different conditions may be different from each other.

The electronic device 101 sets at least one of the first relationship information 1131 to the fifth relationship information 1113 according to information input into the electronic device 101 in advance. For example, the electronic device 101 receives information indicating that the first relationship information 1131 corresponds to a relationship between the target A 1101 to be identified and the first receiver B 1111, which corresponds to a loving relationship, and set the first relationship information 1131 as information on the loving relationship according to the received information. The electronic device 101 receives information indicating that the first receiver B 1111 corresponds to the superior and the electronic device 101 corresponds to the subordinate, and set the fourth relationship information 1112 as the information on the relationship between a subordinate and a superior according to the received information. The relationship information may be pre-stored in the electronic device 101, or may be learned from one or more pieces of information through a sensor and inferred by the electronic device 101. A result of the inference of the relationship information may be made as a database and stored in a memory which the electronic device 101 can access.

The electronic device 101 manages a relationship matrix about the relationship between the receiver and the electronic device 101 and between the target to be authentication and the receiver, and may include information on the relationship between the target to be authenticated and the electronic device 101. For example, in the relationship matrix, between the receiver and the electronic device 101, an informal characteristic may be reflected as a friendship, a formal characteristic may be reflected as a secretary-boss relationship, and a sensitive and love characteristic may be reflected as a loving relationship. Characteristics of fad words of a celebrity, a voice, and the like may be reflected in the relationship matrix according to user settings.

When the relationship between the receiver and the sender is intimate like the relationship between family members or friends, the appellation and the output message may be re-processed. In the case of an official relationship, the contents may be generated by polite words. Further, in a special relationship, nicknames used between the receiver and the sender may be included.

FIGS. 11B, 11C, 11D and 11E illustrate an output message conversion according to embodiments of the present disclosure. In FIGS. 11B, 11C, 11D and 11E, it is assumed that the electronic device 101 generates an output message “James is wearing long sleeves” based on the authentication result and the identification result of the second part.

Referring first to FIG. 11B, the electronic device 101 determines that the target 520 to be authenticated is James which is the same as the receiver, converts the output message according to relationship information between the electronic device 101 and the target 520 to be authenticated, and provides the converted output message. For example, the electronic device 101 sets the relationship information between the electronic device 101 and the target 520 to the authenticated, who is James, as a friendship relationship. The electronic device 101 converts the output message “James is wearing long sleeves” into a message “Dude, you wear long sleeves” 1151 based on the relationship information corresponding to the friend relationship and output the converted output message. For example, the electronic device 101 converts the output message by adding “Dude” corresponding to an appellation used between friends to the output message. As illustrated in FIG. 11C, the electronic device 101 sets the relationship information between the electronic device 101 and the target 520 to be authentication who is James as a relationship between subordinates and superiors. The electronic device 101 converts the output message “James is wearing long sleeves” into a message “Mr. James, you wear long sleeves” 1152 based on the relationship information corresponding to the relationship between subordinates and superiors and output the converted output message. For example, the electronic device 101 converts the output message by adding “Mr.” corresponding to an appellation used between subordinates and superior to the output message. According to embodiments of the present disclosure, with respect to the same target to be authenticated, the electronic device 101 provides different output messages 1151 and 1152 according to relationship information.

Referring to FIG. 11D, the electronic device 101 determines that the target 520 to be authenticated is James and a receiver 1170 is Clara. The electronic device 101 sets relationship information between the electronic device 101 and the target 520 to be authenticated as a relationship between subordinates and superior. The electronic device 101 sets relationship information between the electronic device 101 and the receiver 1170 as a friendship relationship. In addition, the electronic device 101 sets relationship information between the target 520 to be authenticated and the receiver 1170 as the relationship between subordinates and superior. The electronic device 101 may add the appellation such as “Mr.” to the output message based on the relationship between subordinates and superior which is the relationship information between the electronic device 101 and the target 520 to be authenticated. The electronic device 101 may add an appellation such as “Buddy” based on the relationship information corresponding to the friendship relationship between the electronic device 101 and the receiver 1170. In addition, the electronic device 101 determines to maintain the appellation “Mr.” based on the relationship information corresponding to the relationship between subordinates and superior between the target 520 to be authenticated and the receiver 1170. The electronic device 101 outputs a message “Buddy, Mr. James is wearing long sleeves” 1171 converted from the output message based on relationship information.

Referring to FIG. 11E, the electronic device 101 determines that the target 520 to be authenticated is James and a receiver 1180 is a child. The electronic device 101 sets relationship information between the electronic device 101 and the target 520 to be authenticated as a relationship between subordinates and superior. The electronic device 101 sets relationship information between the electronic device 101 and the receiver 1180 as a friendship relationship. In addition, the electronic device 101 sets relationship information between the target 520 to be authenticated and the receiver 1180 as a father-son relationship. The electronic device 101 may add an appellation “Dude” based on the relationship information corresponding to the friendship relationship between the electronic device 101 and the receiver 1180. The electronic device 101 may add an appellation “Dad” based on the relationship information corresponding to the father-son relationship between the target 520 to be authenticated and the receiver 1180. The electronic device 101 outputs a message “Dude, Dad is wearing long sleeves” 1181 converted from the output message based on the relationship information. As described above, the electronic device 101 provides different output messages according to the receiver with respect to the same target to be authenticated.

The electronic device 101 may collect various pieces of information related to the target A 1101 to be authenticated, the first receiver B 1111, and the second receiver C 1112 and set various pieces of relationship information by analyzing the collected information. For example, the electronic device 101 photographs a gesture of the target A 1101 to be authenticated and analyze the gesture according to a photographing result. The electronic device 101 determines that the target A 1101 to be authenticated has made a gesture of stroking the first receiver B 1111 and, in this case, determines that the gesture is classified into intimacy. The electronic device 101 sets the first relationship information 1131 between the target A 1101 to be authenticated and the electronic device 101 as the loving relationship according to the collected information, that is, the gesture.

Alternatively, the electronic device 101 may collect information in various schemes such as message analysis, voice recognition, and web analysis as well as the photographing and set the relationship information. Table 3 is an example of information used for setting relationship information according to embodiments of the present disclosure.

TABLE 3

| Relationship information | |
|---|---|
| determination reference | Relationship information determination method |
| Gesture | The electronic device 101 determines a |
| | relationship through a gesture between users. |
| Face | The electronic device 101 may register a |
| | relationship according to face recognition |
| | in an initial set and then determine a |
| | relationship according to the recognized |
| | face according to a photographing result. |
| Body language | The electronic device 101 may understand a |
| | relationship between users according to a body |
| | language mainly used by the user. |
| Voice recognition | The electronic device 101 determines a relationship |
| | according to voice recognition and determine a |
| | relationship through appellation. |
| Distance between people | The electronic device 101 determines intimacy |
| | according to the distance between people. |
| Meeting frequency | The electronic device 101 determines intimacy |
| | according to the frequency people are together in |
| | an image frame acquired as a photographing result. |
| Address book | The electronic device 101 may understand a |
| | relationship between users by detecting relationship |
| | information in at least one accessible address book. |
| social networking | The electronic device 101 may understand a |
| service (SNS) | relationship between users by analyzing data of |
| information | accessible SNS. |
| Query-response | The electronic device 101 may inquire about |
| information | relationship information to the user and understand |
| | relationship information according to information |
| | from a response thereto. |
| Context information | The electronic device 101 may understand |
| | relationship information according to contents |
| | included in a message. |
| Place | The electronic device 101 may understand |
| | relationship information according to a |
| | transmission or reception place of a message. |
| Time | The electronic device 101 may understand |
| | relationship information according to a |
| | writing and reception time of a message. |

As described above, the electronic device 101 may understand a relationship between people according to various references and set the relationship in advance or set the relationship when the message is transmitted and received.

The aforementioned loving relationship, father-son relationship, and relationship between subordinates and superiors are only examples, and the electronic device 101 according to embodiments of the present disclosure sets various pieces of relationship information on family members, friends, subordinates and superiors, a secretary, lovers, colleagues, strangers. The electronic device 101 sets the relationship information according to an intimacy level, and digitizes and manages the relationship information.

The electronic device 101 learns and sets the relationship information, and reset and update the relationship information.

As described above, the electronic device 101 converts the message based on relationship information between the sender and receiver and relationship information between the receiver and electronic device 101, so that a service to transfer the message through personification of the electronic device 101 may be provided.

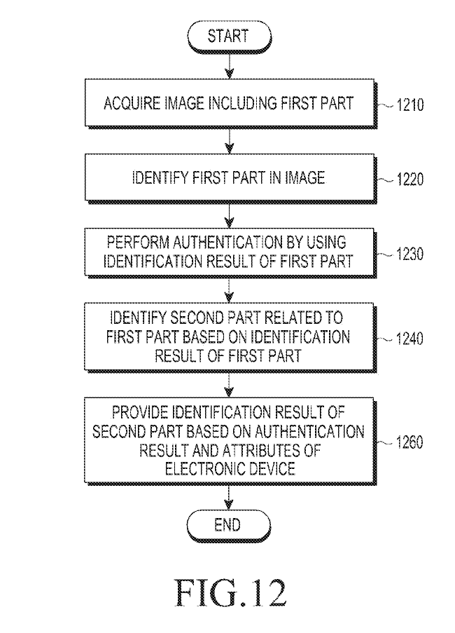

FIG. 12 illustrates a control method of the electronic device according to embodiments of the present disclosure.

In step 1210, the electronic device 101 acquires an image including a first part. In step 1220, the electronic device 101 identifies the first part in the image. In step 1230, the electronic device 101 performs an authentication by using an identification result of the first part. In step 1240, the electronic device 101 identifies a second part related to the first part based on a result of the identification of the first part.

In step 1260, the electronic device 101 provides a result of the identification of the second part based on an authentication result and attributes of the electronic device. The attributes of the electronic device may indicate a status of the electronic device in a relative relationship with the target to be authenticated or the receiver. The attributes of the electronic device 101 may be implemented to be a friend, secretary, brothers and sisters, parents, worker of particular job, and child, and there is no limitation if the attributes indicate the status in the relationship. The attributes of the electronic device 101 may be preset or determined by data collected by the electronic device 101. The electronic device 101 determines various pieces of relationship information based on the attributes, and converts and outputs an output message including the identification result of the second part based on the determined relationship information.

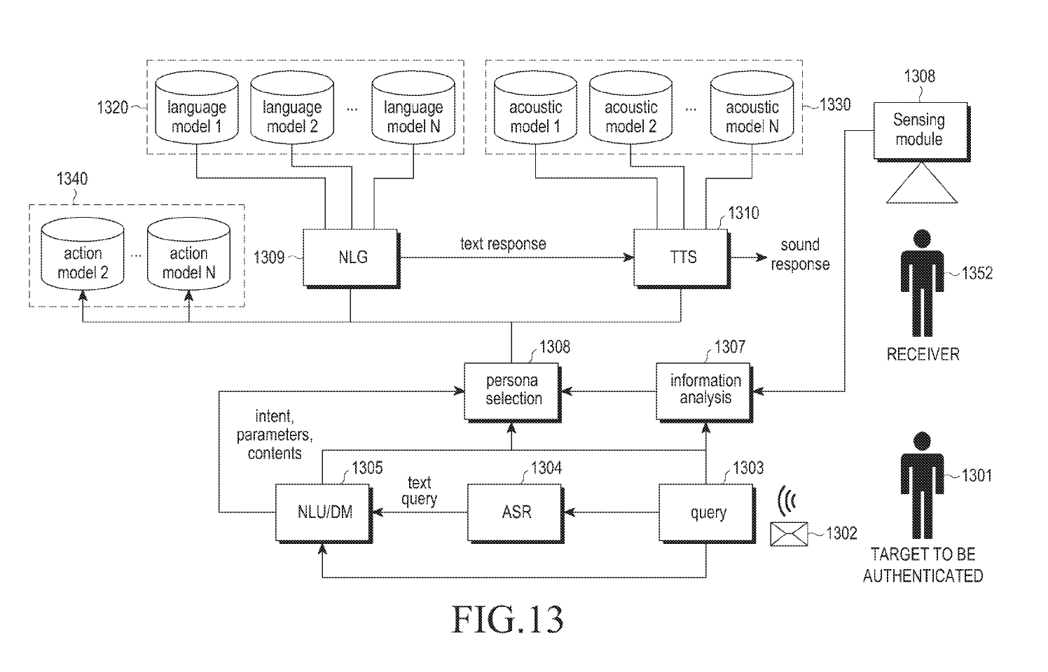

FIG. 13 illustrates a message conversion of the electronic device according to embodiments of the present disclosure.

The electronic device 101 generates a target 1301 to be authenticated and an output message 1301 including a part recognition result as an image. The electronic device 101 queries 1306 about the output message 1302 through a voice and perform acoustic speech recognition 1304. Alternatively, the electronic device 101 may make the query 1303 about metadata of the message 1302 and perform information analysis 1307. Particularly, the electronic device 101 performs the information analysis 1307 through a sensing module 1308 and determines a receiver 1352 based on collected information. The electronic device 101 may use information on a receiver 1352 based on persona selection 1306.

The electronic device 101 acquires text through a result of the acoustic speech recognition 1304 and performs natural language understanding (NLU)/dialog management (DM) 1305 based on the text as the query. The text may be recognized as a sentence through the NLU and the DM. The electronic device 101 may use at least one of the intent, parameter, and content acquired through the NLU and the DM 1305 for the persona selection 1306. The electronic device 101 may use the query 1303 of the message 1302 for the persona selection 1306.

The electronic device 101 may select one of one or more language models 1320 through a natural language generator (NLG) 1309 based on the persona selection. For example, the electronic device 101 determines at least one text generation parameter.

The electronic device 101 may select one of one or more action modules 1340 based on the persona selection. For example, the electronic device 101 determines at least one action model 1340.

The electronic device 101 may select one of one or more acoustic models 1330 based on the persona selection. For example, the electronic device 101 determines at least one voice generation parameter to output a text-converted message through the NLG 1309. The electronic device 101 outputs a sound response according to the selected acoustic model. The electronic device 101 outputs the voice response by performing text-to-speech (TTS) 1310.

The electronic device 101 may change a factor on the NLG and the TTS module according to a relationship between one or more entities or contents to be transferred and provide a dynamic result to the interacting user.

The electronic device 101 may use not only contents of a message to be transferred but also a vision for identifying at least one user and environment, a voice sensor, connectivity, and personal profile data in a process of the persona selection 1306. In the language model 1320, different language models may be determined according to the receiver 1352 and the electronic device 101. For example, when the relationship between the receiver 1352 and the electronic device 101 is set as friendship by a pre-setting or learning, a language model for constructing words and sentences indicating intimacy may be selected, and an acoustic model having a rapid clear ton feature may be selected and the language is converted for an emergency message according to the message to be transferred to the user.

The electronic device 101 may also change an acoustic model of a voice in a high frequency band into an acoustic model of a voice in a low frequency band and output the voice based on information indicating that the receiver is weak at listening the voice in the high frequency band.

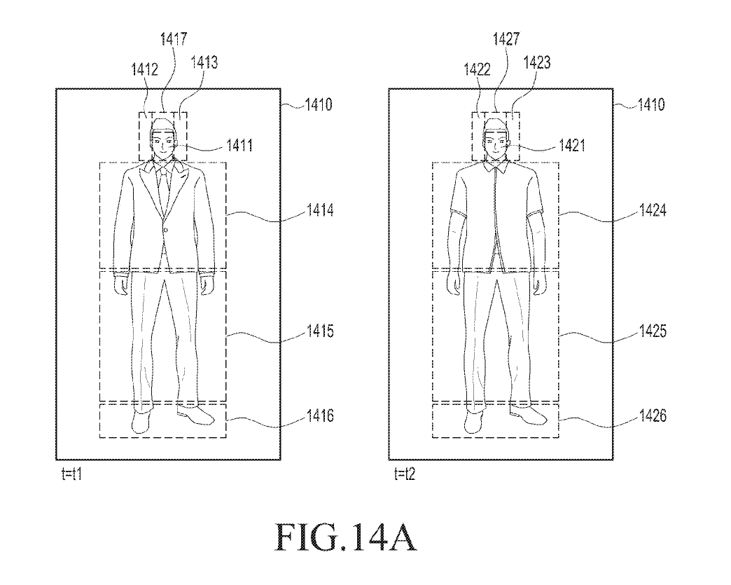

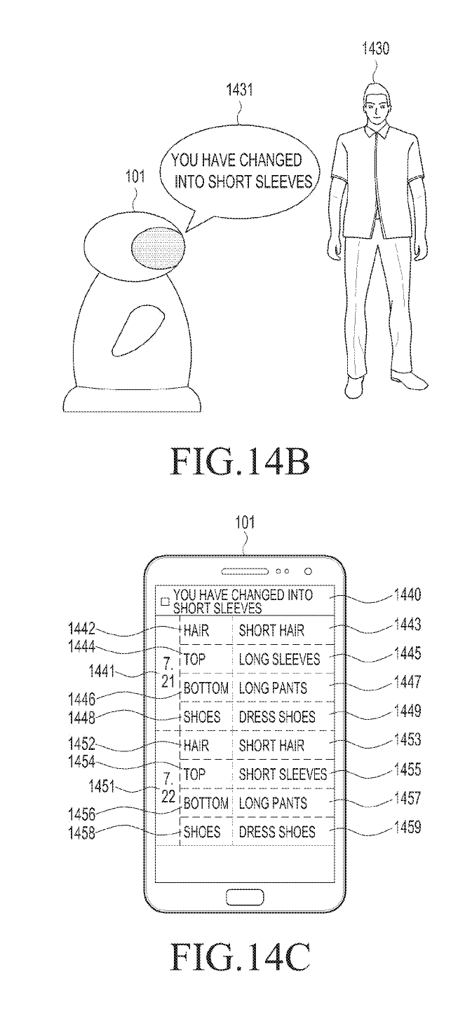

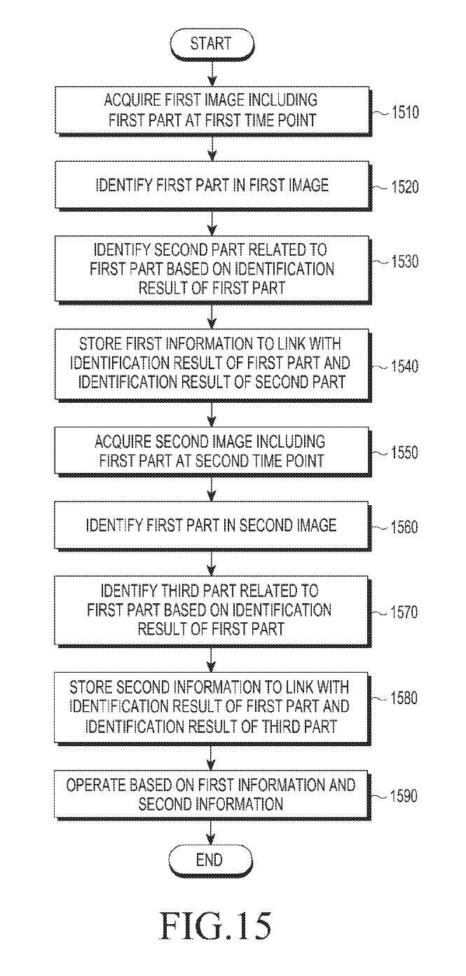

FIGS. 14A, 14B and 14C illustrate image processing according to embodiments of the present disclosure. The embodiment of FIG. 14A will be described in more detail with reference to FIG. 15, which illustrates a control method of the electronic device according to embodiments of the present disclosure.

Referring to FIGS. 14A and 15, in step 1510, the electronic device 101 acquires a first image 1410 including a first part 1411 at a first time point t1. In step 1520, the electronic device 101 identifies the first part 1411 in the first image 1410. In step 1530, the electronic device 101 identifies second parts 1412 to 1417 related to the first part 1411 based on the identification result of the first part 1411. In step 1540, the electronic device 101 stores first information to be associated with the identification result of the first part 1411 and the identification results of the second parts 1412 to 1417.

In step 1550, the electronic device 101 acquires a second image 1420 including a first part 1421 at a second time point t2. In step 1560, the electronic device 101 identifies the first part 1411 in the second image 1420. In step 1570, the electronic device 101 identifies third parts 1422 to 1427 related to the first part 1421 based on the identification result of the first part 1421. In step 1580, the electronic device 101 stores second information to be associated with the identification result of the first part 1421 and the identification results of the third parts 1422 to 1417.

In step 1590, the electronic device 101 may operate based on the first information and the second information. For example, as illustrated in FIG. 14B, the electronic device 101 provides an output message 1431 based on a result of a comparison between the first information and the second information to a user 1430. More specifically, the electronic device 101 provides the output message 1431 including an analysis result of “You changed into short sleeves” based on first information indicating the identification result of the second part 1414 in the first image 1410 corresponds to long sleeves and second information indicating that the identification result of the third part 1424 in the second image 1420 corresponds to short sleeves.

The electronic device 101 displays a result 1440 of storage of the first information and the second information as illustrated in FIG. 14C. For example, the electronic device 101 may classify various second part categories 1442, 1444, 1446, 1448, 1452, 1454, 1456, and 1458 according to dates 1441 and 1451 and display the classified second part categories. The electronic device 101 displays second part recognition results 1443, 1445, 1447, 1449, 1453, 1455, 1457, and 1459 according to the categories 1442, 1444, 1446, 1448, 1452, 1454, 1456, and 1458. The electronic device 101 provides information generated by analyzing the storage result as well as simply displaying the storage result. For example, the electronic device 101 analyzes information indicating that the user continuously wears the same long pants in bottom categories 1446 and 1456 and provides analysis information that proposes to change the pants.

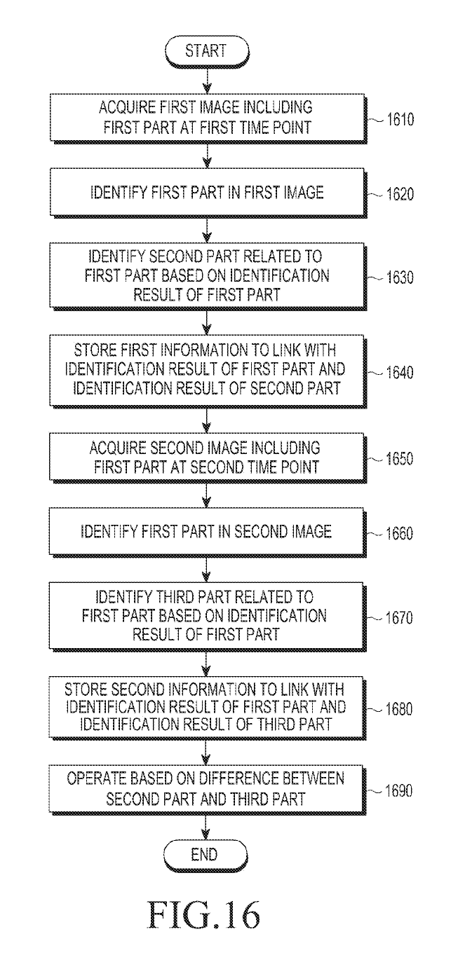

FIG. 16 illustrates a control method of the electronic device according to embodiments of the present disclosure.

In step 1610, the electronic device 101 acquires a first image including a first part at a first time point. In step 1620, the electronic device 101 identifies the first part in the first image. In step 1630, the electronic device 101 identifies a second part related to the first part based on a result of the identification of the first part. In step 1640, the electronic device 101 stores first information to be associated with the identification result of the first part and the identification result of the second part. In step 1650, the electronic device 101 acquires a second image including a first part at a second time point. In step 1660, the electronic device 101 identifies the first part in the second image. In step 1670, the electronic device 101 identifies a third part related to the first part based on the identification result of the first part. In step 1680, the electronic device 101 stores second information to be associated with the identification result of the first part and the identification result of the third part. The second part may be an object of a first area to be identified in the first image and the third part may be an object of a first area to be identified in the second image. That is, the second part and the third part may be objects corresponding to the same area to be identified.

In step 1690, the electronic device 101 may operate based on a difference between the second part and the third part. As described above, the second part and the third part may be parts corresponding to the same area to be identified and, when a change between the second part and the third part is detected, the electronic device 101 may operate based on the detected change. The electronic device 101 may detect the change by comparing the difference with a predetermined threshold value.

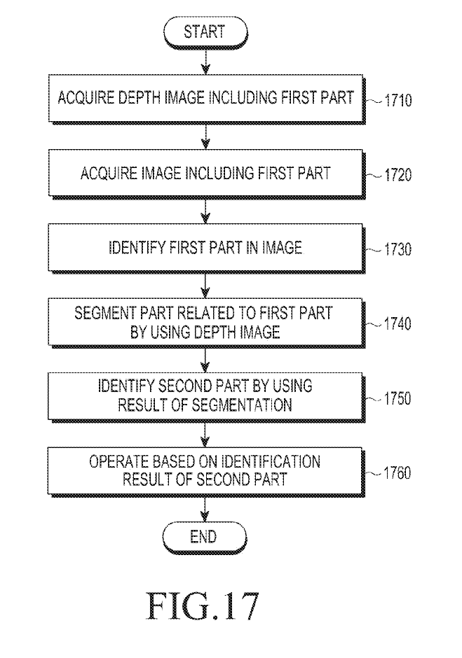

FIG. 17 illustrates a control method of the electronic device according to embodiments of the present disclosure.

In step 1710, the electronic device 101 acquires a depth image including a first part. In step 1720, the electronic device 101 acquires an image including the first part. The electronic device 101 acquires the depth image corresponding to the acquired image. The electronic device 101 may include a depth camera module such as a time of flight (TOF) camera module, a stereoscopic camera module, and a camera module including phrase pixels of 2 photo-diode (2PD), which acquires a depth image, and acquires the depth image by performing photographing through the depth camera module at an image acquisition time point. Alternatively, the electronic device 101 acquires the depth image by analyzing the acquired image. The electronic device 101 may pre-store an algorithm which acquires a depth value according to each part within the image from a two dimensional image, and acquire the depth image by applying the algorithm to the acquired image.

In step 1730, the electronic device 101 identifies the first part in the image. In step 1740, the electronic device 101 performs segmentation on a part related to the first part by using the depth image. For example, the electronic device 101 performs segmentation on parts having depth values which are different from the first part by a predetermined threshold value or less. More specifically, the electronic device 101 performs the segmentation by separating the part related to the first part from the image.

In step 1750, the electronic device 101 identifies the second part by using a result of the segmentation. The electronic device 101 may select a second part corresponding to a preset area to be identified from the result of the segmentation and identify the selected second part.

In step 1760, the electronic device 101 may operate based on the identification result of the second part.

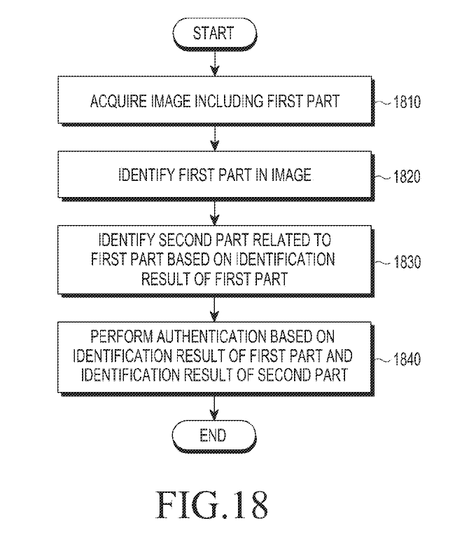

FIG. 18 illustrates a control method of the electronic device according to embodiments of the present disclosure.

In step 1810, the electronic device 101 acquires an image including the first part. In step 1820, the electronic device 101 identifies the first part in the image. In step 1830, the electronic device 101 identifies a second part related to the first part based on a result of the identification of the first part.

In step 1840, the electronic device 101 performs an authentication based on the identification result of the first part and the identification result of the second part. That is, in contrast to the embodiment of FIG. 9, the electronic device 101 according to the embodiment of FIG. 18 performs an authentication by using the identification result of the second part as well as the identification result of the first part. According to another embodiment, the electronic device 101 performs the authentication by using only the identification result of the second part.

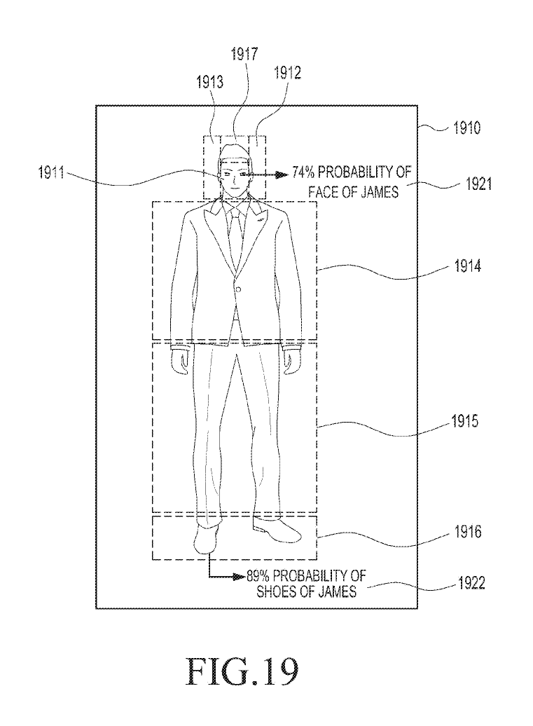

FIG. 19 illustrates an authentication process according to embodiments of the present disclosure. The electronic device 101 acquires an image 1910 including a first part 1911. The electronic device 101 may apply an object recognition algorithm to the image 1910 and detect the first part 1911 a face part based on a result of the application. The electronic device 101 identifies one or more second parts 1912 to 1917 related to the first part 1911 based on the identification result of the first part 1911.

The electronic device 101 performs an authentication by using the first part 1911. For example, the electronic device 101 acquires an authentication result 1921 indicating a 74% probability that a person within the image 1910 corresponds to James based on the first part 1911. The electronic device 101 acquires an authentication result 1922 indicating an 89% probability that the person within the image 1910 corresponds to James based on the second part 1916. The electronic device 101 determines whether the person within the image 1910 corresponds to James based on the two authentication results 1921 and 1922. The electronic device 101 performs a final authentication based on a weighted sum of the two authentication results. According to embodiments of the present disclosure, the electronic device 101 may first perform the authentication based on the identification result of the first part 1911 and then, when the authentication result is unclear, perform the authentication by additionally using the identification result of the second parts 1912 to 1917.

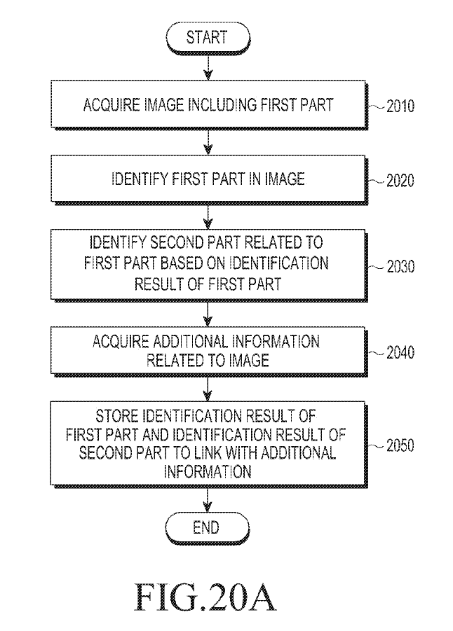

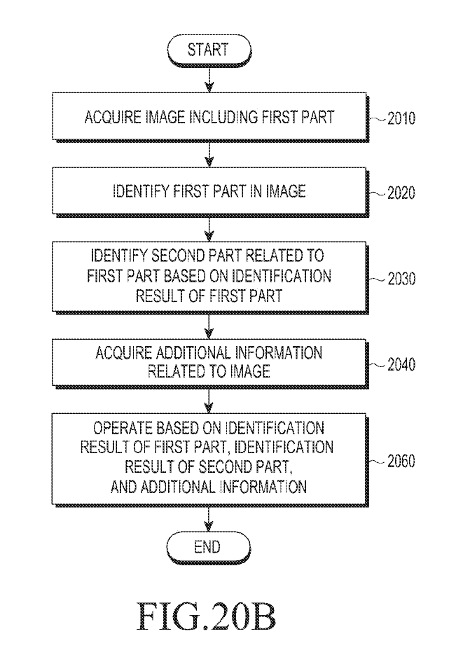

FIG. 20A illustrates a control method of the electronic device according to embodiments of the present disclosure.

In step 2010, the electronic device 101 acquires an image including a first part. In step 2020, the electronic device 101 identifies the first part in the image. In step 2030, the electronic device 101 identifies a second part related to the first part based on a result of the identification of the first part.

In step 2040, the electronic device 101 acquires additional information related to the image. The additional information may include at least one of metadata of the acquired image and information acquired by the electronic device 101 at an image photographing time point. A detailed implementation example of the additional information will be described below in more detail.

In step 2050, the electronic device 101 stores the additional information to be associated with the identification result of the first part and the identification result of the second part.

Alternatively, as illustrated in FIG. 20B, the electronic device 101 may operate based on the identification result of the first part, the identification result of the second part, and the additional information in step 2060.

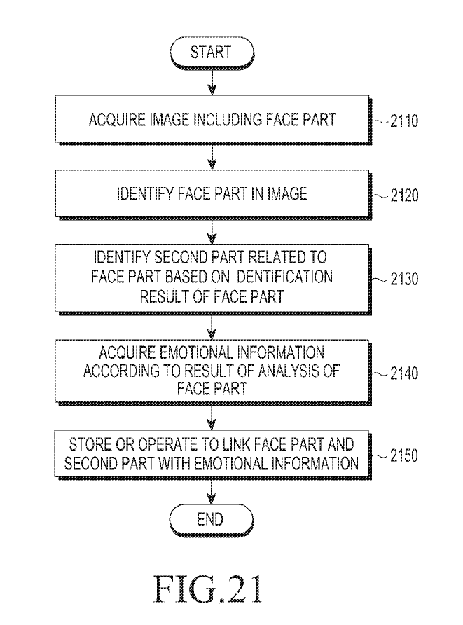

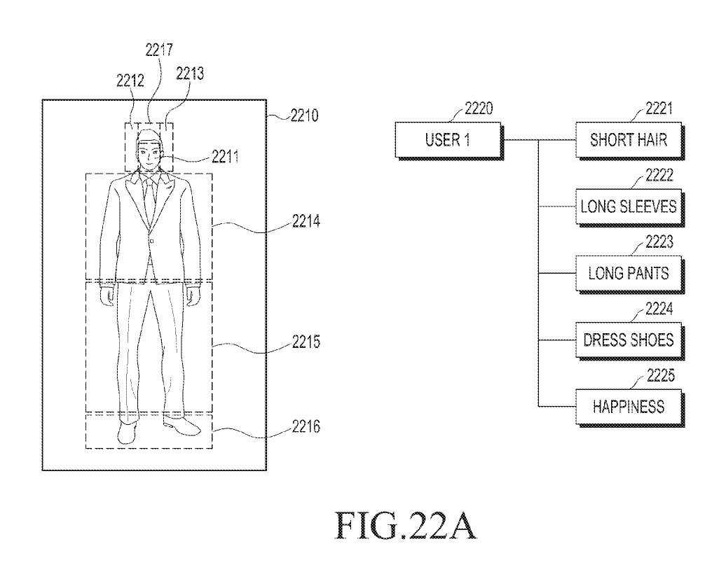

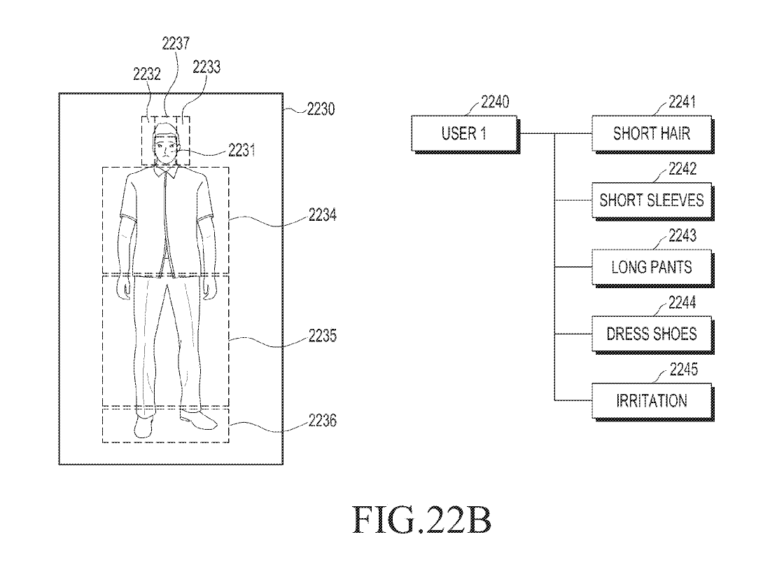

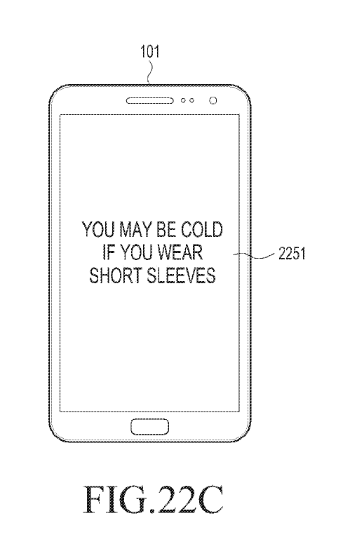

FIG. 21 illustrates additional information processing according to embodiments of the present disclosure. The embodiment of FIG. 21 will be described in more detail with reference to FIGS. 22A, 22B and 22C.

Referring to FIGS. 21 and 22A, in step 2110, the electronic device 101 acquires an image 2210 including a face part 2211. In step 2120, the electronic device 101 identifies the face part 2211 in the image. The electronic device 101 stores a face recognition algorithm, and identifies information indicating that the type of part corresponds to the face and information indicating that the face part 2211 corresponds to smile type. The electronic device 101 acquires facial expression information through an analysis of features of eyes, nose, mouth, and wrinkles in the recognized face part. According to embodiments of the present disclosure, the electronic device 101 performs an authentication by using a result of the identification of the face part 2211. For example, the electronic device 101 determines that a person within the image 2210 corresponds to user #1 based on the identification result.

In step 2130, the electronic device 101 identifies second parts 2212 to 2217 related to the face part based on the identification result of the face part 2211. In step 2140, the electronic device 101 acquires emotional information according to a result of the analysis of the face part. For example, according to the embodiment of FIG. 22A, the electronic device 101 acquires emotional information of happiness as the additional information based on the identification result of the face part corresponding to the smile type.

In step 2150, the electronic device 101 stores or operates to be associated with the face part 2211 and the second parts 2212 to 2217 with the emotional information. For example, as illustrated in FIG. 22A, the electronic device 101 stores identification results 2221 to 2224 of the second parts to correspond to user #1 2220 and additionally stores emotional information 2225 to be associated with at least one of user #1 2220 and the identification results 2221 to 2224 of the second parts.

Referring to FIG. 22B, the electronic device 101 acquires an image 2230 including a face part 2231. The electronic device 101 identifies the face part 2231 in the image. The electronic device 101 stores a face recognition algorithm and identifies information indicating that the type of part corresponds to the face and information indicating that the face part 2231 corresponds to a frown type. The electronic device 101 performs an authentication by using a recognition result of the face part 2231 and determine that a person within the image 2230 corresponds to user #1.

The electronic device 101 identifies second parts 2232 to 2237 related to the face part based on the identification result of the face part 2231. The electronic device 101 acquires emotional information according to the analysis result of the face part. For example, according to the embodiment of FIG. 22B, the electronic device 101 acquires emotional information corresponding to irritation as the additional information based on the recognition result of the face part corresponding to the frown type.

The electronic device 101 stores or operate to be associated with the face part 2231 and the second parts 2232 to 2237 with the emotional information. For example, as illustrated in FIG. 22B, the electronic device 101 stores recognition results 2241 to 2244 of the second part to correspond to user #1 2240 and additionally stores emotional information 2245 to be associated with at least one of user #1 2240 and the recognition results 2241 to 2244 of the second part.

According to embodiments of the present disclosure, the electronic device 101 may detect a change in the additional information. For example, as illustrated in FIGS. 22A and 22B, the electronic device 101 may detect the change in the emotional information from happiness 2225 to irritation 2245, and operate in accordance with the detected change. For example, when the change in the additional information is detected, the electronic device 101 determines whether another piece of information stored together changes. According to the embodiments of FIGS. 22A and 22B, the electronic device 101 determines that second parts 2222 and 2242 correspond to the top have changed from long sleeves into short sleeves, and provides an output message 2251 illustrated in FIG. 22C based on a result of the determination.

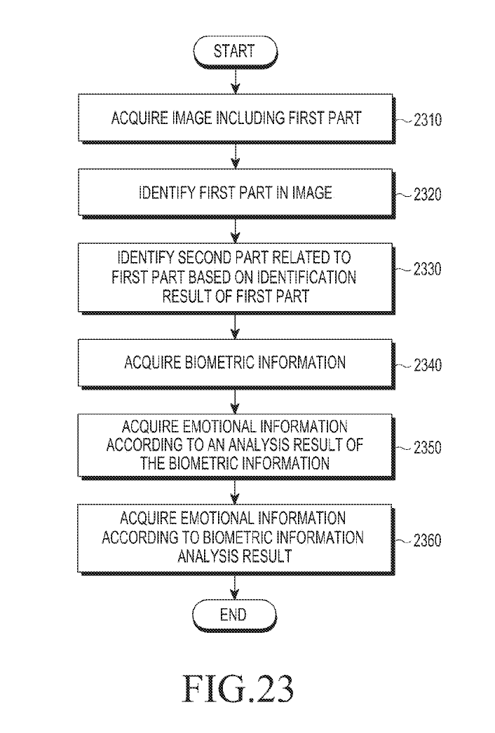

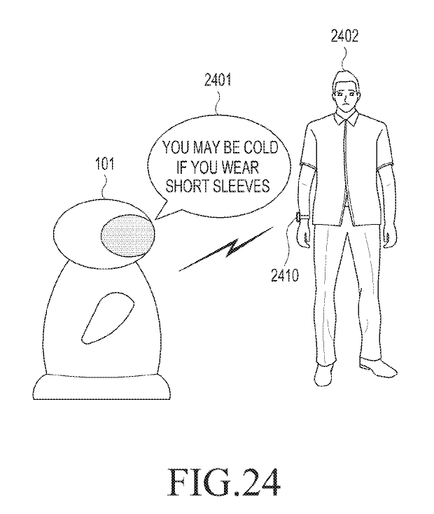

FIG. 23 illustrates additional information processing according to embodiments of the present disclosure. The embodiment of FIG. 23 will be described in more detail with reference to FIG. 24.

In step 2310, the electronic device 101 acquires an image including a first part. In step 2320, the electronic device 101 identifies the first part in the image. In step 2330, the electronic device 101 identifies a second part related to a first part based on a result of the identification of the first part.

In step 2340, the electronic device 101 acquires biometric information. The electronic device 101 acquires the detected biometric information at a time point corresponding to an image acquisition time point. The biometric information may include at least one of a brainwave signal, an EEG (Electroencephalogram) signal, an ECG (Electrocardiogram) signal, an EMG (Electromyograph) signal, an EOG (Electrooculogram) signal, a blood pressure, and a body temperature, and there is no limitation in the biometric information if the biometric information indicates a biometric status. The electronic device 101 may include a sensor that may detect the biometric information and acquire the biometric information through the sensor. Alternatively, as illustrated in FIG. 24, the electronic device 101 acquires the biometric information from another electronic device 2410 including the sensor. Alternatively, the biometric information acquired from the other electronic device 2410 may be stored in a server, and the electronic device 101 acquires the biometric information from a server.

In step 2350, the electronic device 101 acquires emotional information according to an analysis result of the biometric information. The electronic device 101 acquires the emotional information through a weighted sum result of various pieces of biometric information. In step 2360, the electronic device 101 stores or operates to line the face part and the second part with the emotional information. For example, according to the embodiment of FIG. 24, the electronic device 101 determines that a user's emotional status corresponds to irritation based on biometric information of a user 2402. The electronic device 101 identifies a part having a change in the second parts based on the emotional status of the irritation and provides an output message 2401 including information related to the part having the change.

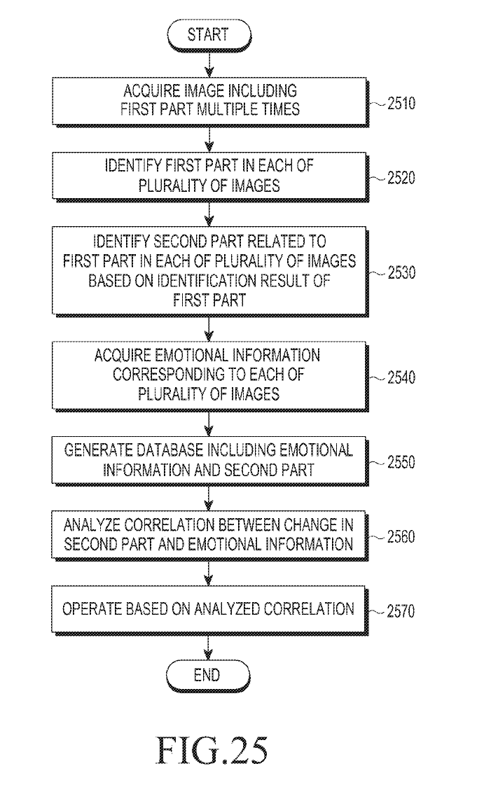

FIG. 25 illustrates additional information processing according to embodiments of the present disclosure.

In step 2510, the electronic device 101 acquires an image including a first part multiple times. In step 2520, the electronic device 101 identifies the first part in each of a plurality of images. In step 2530, the electronic device 101 identifies a second part related to the first part in each of the plurality of images based on an identification result of the first part. In step 2540, the electronic device 101 acquires emotional information corresponding to each of the plurality of images.

In step 2550, the electronic device 101 generates a database including the second part and the emotional information. In step 2560, the electronic device 101 analyzes a correlation between the change in the second part and the emotional information. In step 2570, the electronic device 101 may operate based on the analyzed correlation. For example, the electronic device 101 determines whether the emotional information changes when a top part is changed. The electronic device 101 determines the correlation between the part and the emotional information by analyzing the change in the part and the change in the emotional information. For example, when the user's emotional information corresponds to irritation, the electronic device 101 provides an output message that recommends a second part corresponding to when the emotional information is happiness.

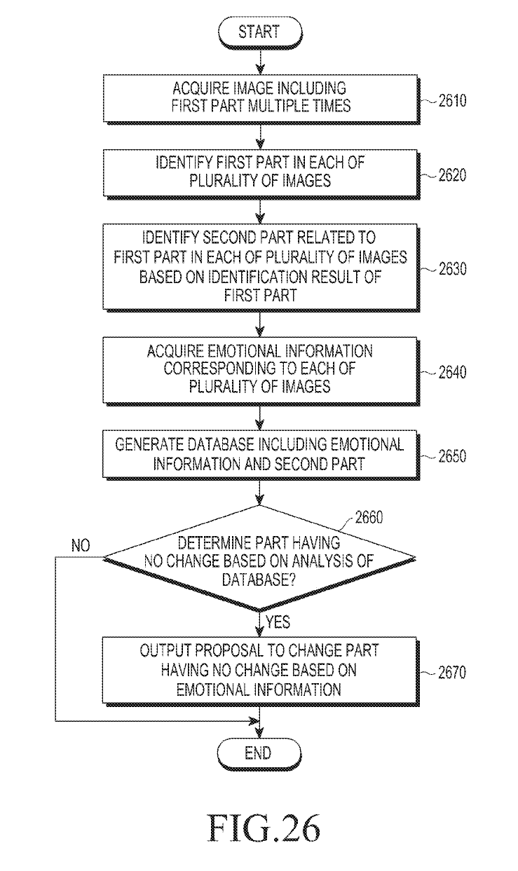

FIG. 26 illustrates additional information processing according to embodiments of the present disclosure.

In step 2610, the electronic device 101 acquires an image including a first part multiple times. In step 2620, the electronic device 101 identifies the first part in each of a plurality of images. In step 2630, the electronic device 101 identifies a second part related to the first part in each of the plurality of images based on an identification result of the first part. In step 2640, the electronic device 101 acquires emotional information corresponding to each of the plurality of images. In step 2650, the electronic device 101 generates a database including the second part and the emotional information.

In step 2660, the electronic device 101 determines a part having no change by analyzing the database. In step 2670, the electronic device 101 outputs a proposal to change the part having no change based on the emotional information. For example, the electronic device 101 provides an output message including information on a part corresponding to when the emotional status is happiness.

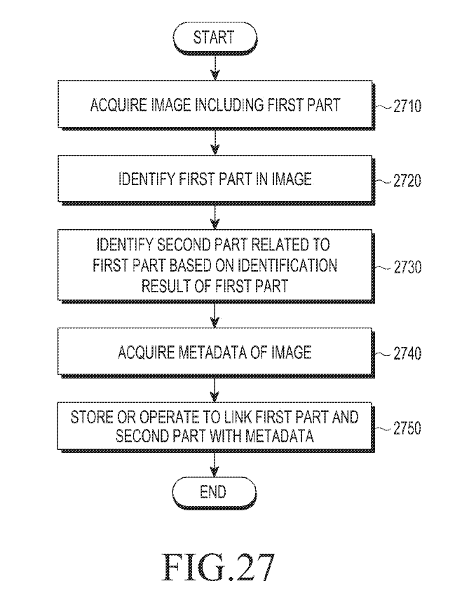

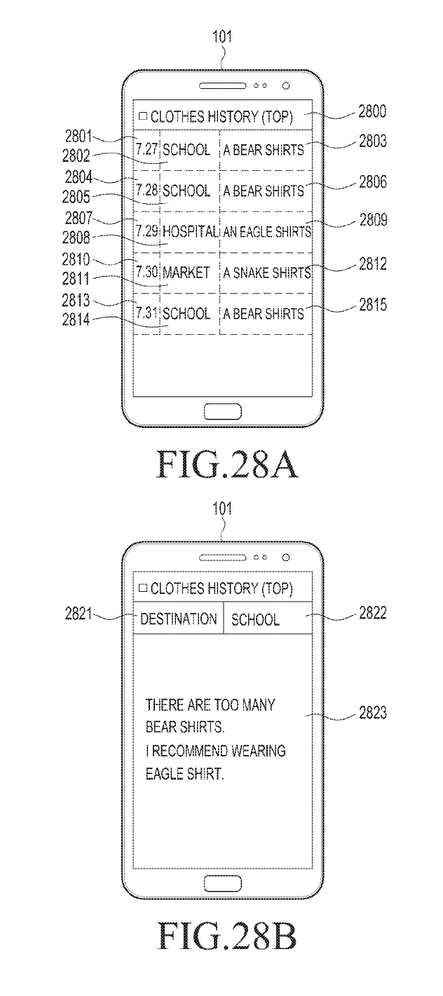

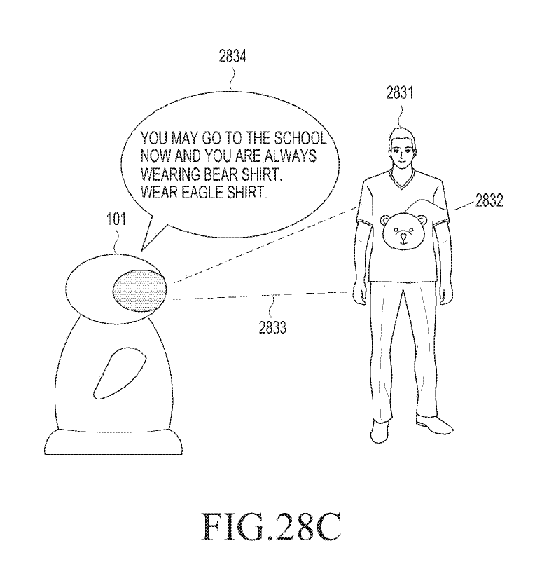

FIG. 27 illustrates a control method of the electronic device according to embodiments of the present disclosure. The embodiment of FIG. 27 will be described in more detail with reference to FIGS. 28A to 28C. FIGS. 28A to 28C illustrate additional information processing of a place according to embodiments of the present disclosure.

In step 2710, the electronic device 101 acquires an image including a first part. In step 2720, the electronic device 101 identifies the first part in the image. In step 2730, the electronic device 101 identifies a second part related to the first part based on a result of the identification of the first part.

In step 2740, the electronic device 101 acquires metadata of the image. For example, the metadata of the image may include information on a place where the image is photographed. According to another embodiment, the electronic device 101 determines a place at an image photographing time point through hardware such as a GPS module.

In step 2750, the electronic device 101 stores the first part and the second part to be associated with the metadata or operate. For example, as illustrated in FIG. 28A, the electronic device 101 displays a graphic user interface 2800 including a database. The electronic device 101 displays place information 2802, 2805, 2808, 2811, and 2814 and identification results 2803, 2806, 2809, 2812, and 2815 of the second part to correspond to each other according to dates 2801, 2804, 2807, 2810, and 2813.

The electronic device 101 displays a database analysis result as illustrated in FIG. 28B. For example, when a destination 2821 is set as a school 2822, the electronic device 101 displays an analysis result 2823 of the identification result of the second part corresponding to the place of the school. For example, the electronic device 101 determines that the place of the school 2822 matches a plurality of bear shirts. Accordingly, the electronic device 101 provides an output message 2823 that informs that the plurality of bear shirts are worn and proposes another shirt as a result of the determination. The electronic device 101 may additionally store emotional information and, when the emotional information corresponds to happiness, propose a corresponding second part.

When the electronic device 101 is implemented in a robot type, the electronic device 101 outputs a voice message 2834 to a user 2831 as illustrated in FIG. 28C. More specifically, the electronic device 101 photographs the user 2831 wearing a bear shirt 2832 as indicated by reference numeral 2833, and processes the photographed image to identify the bear shirt 2832 as a result of the identification of the second part. The electronic device 101 determines that a destination of the user is school based on a current time of a pre-stored user's schedule. The electronic device 101 determines that a plurality of bear shirts matches the place of the school. Accordingly, the electronic device 101 provides a voice message 2834 that informs that the plurality of bear shirts are worn and proposes another short as a result of the determination.

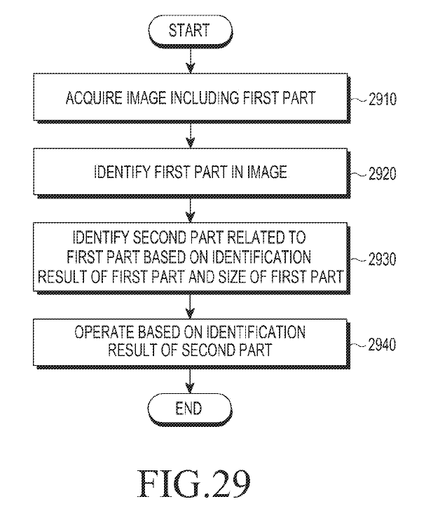

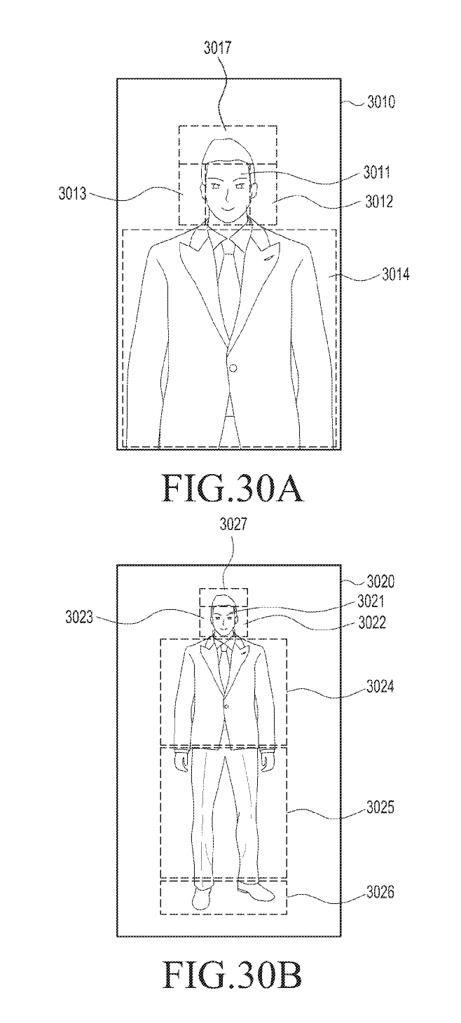

FIG. 29 illustrates a control method of the electronic device according to embodiments of the present disclosure. The embodiment of FIG. 29 will be described in more detail with reference to FIGS. 30A and 30B. FIGS. 30A and 30B illustrate image processing according to embodiments of the present disclosure.

In step 2910, the electronic device 101 acquires an image including a first part. In step 2920, the electronic device 101 identifies the first part in the image. In step 2930, the electronic device 101 identifies a second part related to the first part based on an identification result of the first part and a size of the first part.

For example, as illustrated in FIG. 30A, the electronic device 101 identifies a face part 3011 within an image 3010. The electronic device 101 may detect a size of a face part 3011 and determine a size of an area to be identified in accordance with the size of the face part 3011. For example, the electronic device 101 may differently set sizes of areas 3012 to 3017 to be identified in FIG. 30A and areas 3022 to 3027 to be identified in FIG. 30B. This is because the electronic device 101 detects different sizes of the face parts 3011 and 3021 corresponding to the first part from a plurality of images 3010 and 3020, respectively.

In step 2940, the electronic device 101 may operate based on the identification result of the second part.

The electronic device 101 may drive a camera module based on the size of the first part. For example, the electronic device 101 may adjust a zoom magnification of the camera module to photograph the size of the first part with a preset size.

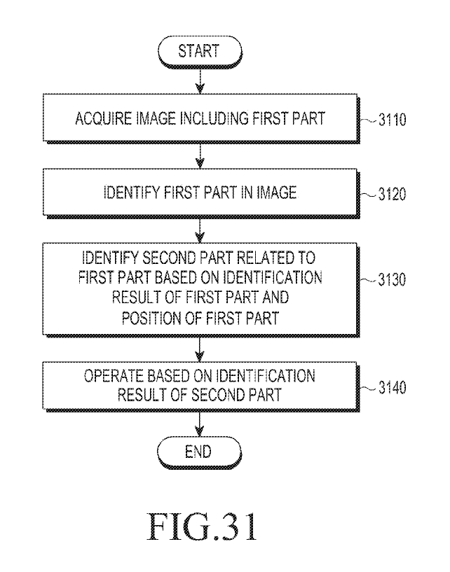

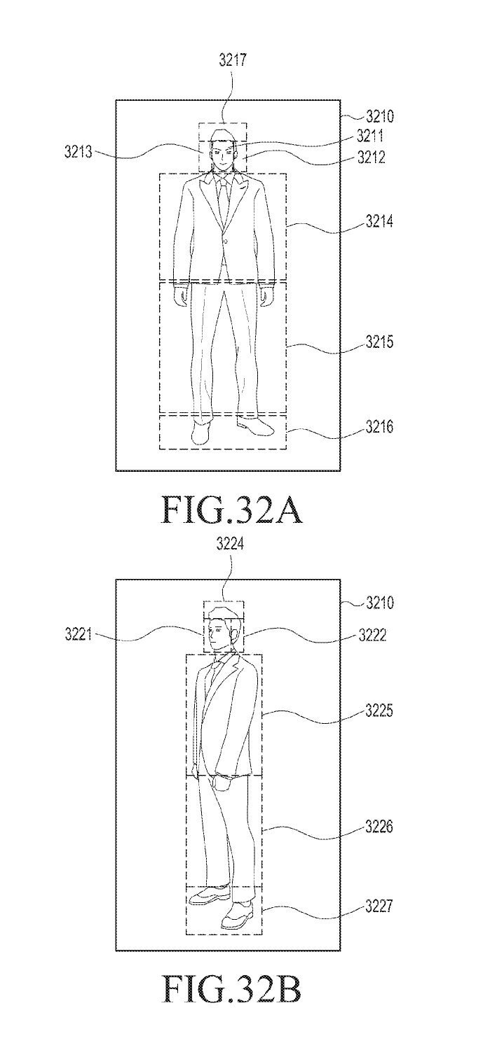

FIG. 31 illustrates a control method of the electronic device according to embodiments of the present disclosure. The embodiment of FIG. 31 will be described in more detail with reference to FIGS. 32A and 32B. FIGS. 32A and 32B illustrate image processing according to embodiments of the present disclosure.

In step 3110, the electronic device 101 acquires an image including a first part. In step 3120, the electronic device 101 identifies the first part in the image. In step 3130, the electronic device 101 identifies a second part related to the first part based on an identification result of the first part and an orientation of the first part.

For example, as illustrated in FIG. 32A, the electronic device 101 identifies a face part 3211 within an image 3210. The electronic device 101 may detect the orientation of the face part 3211 and determine a size of an area to be identified in accordance with the orientation of the face part 3211. According to embodiments of the present disclosure, the electronic device 101 determines the orientation of the face part based on analysis results of various features included in the face part such as eyes, nose, and eyebrows.

For example, the electronic device 101 may differently set sizes of areas 3212 to 3217 to be identified in FIG. 32A and areas 3222 to 3227 to be identified in FIG. 32B. Particularly, in FIG. 32B, the electronic device 101 determines that the orientation of the face part 3221 is not the front surface, and adjusts sizes of the areas 3222 to 3227 to be identified in accordance with the determination. More specifically, the electronic device 101 determines the orientation of the face part 3221 as an angle rotated based on the front surface. The electronic device 101 determines the orientation of the face part 3221 by using two angles of a spherical coordinate system and set the areas 3222 to 3227 to be identified based on the orientation of the face part 3221. For example, in FIG. 32B, the electronic device 101 sets the area 3222 to be identified corresponding to right hair to be horizontally larger than the area 3212 to be identified in FIG. 32A. The electronic device 101 may not set the area to be identified corresponding to left hair in FIG. 32B.

The electronic device 101 may correct the image based on the position information and identify the second part by using the corrected image.

In step 3140, the electronic device 101 may operate based on the identification result of the second part.

According to embodiments of the present disclosure, the electronic device 101 may drive a camera module based on the orientation of the first part. For example, the electronic device 101 may change a photographing angle of the camera module such that the orientation of the first part corresponds to the front surface.

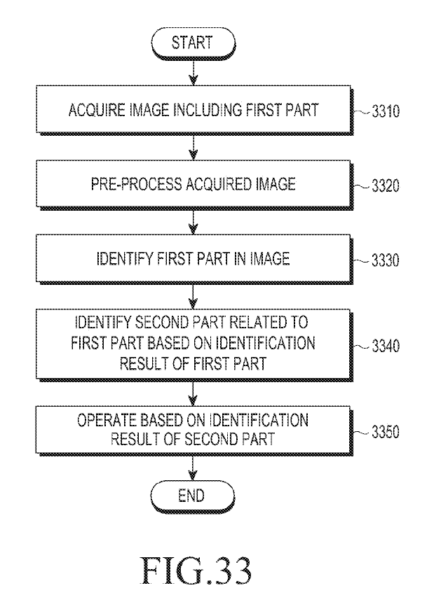

FIG. 33 illustrates a control method of the electronic device according to embodiments of the present disclosure.

In step 3310, the electronic device 101 acquires an image including a first part. In step 3320, the electronic device 101 may pre-process the acquired image. According to embodiments of the present disclosure, the electronic device 101 performs pre-processing including at least one of lighting correction, focus correction, and size correction on the image. For example, the electronic device 101 may predict a light source by analyzing the acquired image and perform pre-processing of correcting predicted light source information. Alternatively, the electronic device 101 may predict focus by analyzing the acquired image and perform pre-processing of correcting the predicted focus. Alternatively, the electronic device 101 analyzes a size of the image by analyzing the acquired image and re-photographs the image by re-adjusting the size or adjusting the camera module such as zoom magnification adjustment.

In step 3330, the electronic device 101 identifies the first part in the pre-processed image. In step 3340, the electronic device 101 identifies a second part related to the first part based on a result of the identification of the first part. In step 3350, the electronic device 101 may operate based on the identification result of the second part.

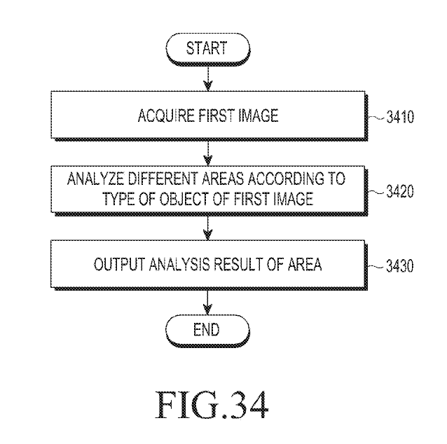

FIG. 34 illustrates a control method of the electronic device according to embodiments of the present disclosure.

In step 3410, the electronic device 101 acquires a first image. In step 3420, the electronic device 101 analyzes different areas according to the type of object in the first image. More specifically, when an object, which can be identified, included in the first image corresponds to a first type, the electronic device 101 analyzes a first area set based on the first type object. When the object, which can be identified, included in the first image corresponds to a second type, the electronic device 101 analyzes a second area set based on the second type object. The first area and the second area may be differently set.

In step 3430, the electronic device 101 outputs an analysis result of the area.

According to embodiments of the present disclosure, a control method of an electronic device may include acquiring an image including a first object, identifying a first part of the first object in the image, identifying a second part related to the first part based on a result of the identification of the first part, and performing an operation based on a result of the identification of the second part.

The control method of the electronic device may further include determining an area to be identified corresponding to the first part and identifying the second part by identifying an object in the area to be identified.

The control method of the electronic device may further include comparing the object in the area to be identified with a pre-stored database and identifying the second part based on a result of the comparison.

The control method of the electronic device may further include performing an authentication by using an identification result of the first part and performing an operation based on an identification result of the second part and the authentication.

The control method of the electronic device may further include performing an authentication by using the identification result of the first part and the identification result of the second part.

The control method of the electronic device may further include acquiring a depth image corresponding to the image and segmenting the first part and the second part in the image based on depth information of the acquired depth image.

The control method of the electronic device may further include acquiring additional information related to the image and performing an operation based on the identification result of the second part and the additional information. The additional information may include at least one of metadata of the image and information acquired by the electronic device when the image is photographed.

The control method of the electronic device may further include determining a correlation between the additional information and the identification result of the second part and storing instructions to output information related to the correlation.

The control method of the electronic device may further include determining a size of the first part, determining an area to be identified corresponding to the first part based on the size of the first part, and storing instructions to identify the second part by identifying an object in the area to be identified.

The control method of the electronic device may further include determining an orientation of the first part, determining an area to be identified corresponding to the first part based on the orientation of the first part, and identifying an object in the area to be identified, and to identify the second part.

The control method of the electronic device may further include performing pre-processing including at least one of lighting correction, focus correction, and size adjustment on the image.

A control method of an electronic device may include acquiring an image including a first part, identifying the first part in the image, identifying a second part related to the first part based on an identification result of the first part, and storing the identification result of the first part and an identification result of the second part to be associated with each other.

The control method of the electronic device may further include performing an authentication by using at least one of the identification result of the first part and the identification result of the second part and storing the identification result of the first part and the identification result of the second part to be associated with a result of the authentication

The control method of the electronic device may further include acquiring additional information related to the image and storing the identification result of the first part and the identification result of the second part to be associated with the additional information. The additional information may include at least one of metadata of the image and information acquired by the electronic device when the image is photographed.

A control method of an electronic device may include acquiring a plurality of images including a first part, identifying the first part in each of the plurality of images, identifying a second part related to the first part in each of the plurality of images based on an identification result of the first part, and performing an operation based on an identification result of the second part

The control method of the electronic device may further include performing an operation based on a change in the second part in each of the plurality of images.

The control method of the electronic device may further include acquiring additional information corresponding to each of the plurality of images, determining a correlation between the change in the second part in each of the plurality of images and the additional information, and outputting information related to the correlation.

A control method of an electronic device may include acquiring an image and performing an operation related to at least one part of the image based on a type of a first part included in the image.

Each of the components of the electronic device according to the present disclosure may be implemented by one or more components and the name of the corresponding component may vary depending on a type of the electronic device. In embodiments, the electronic device may include at least one of the above-described elements. Some of the above-described elements may be omitted from the electronic device, or the electronic device may further include additional elements. Further, some of the components of the electronic device according to the embodiments of the present disclosure may be combined to form a single entity, and thus, may equivalently execute functions of the corresponding elements prior to the combination.

The term “module” as used herein may mean a unit including one of hardware, software, and firmware or a combination of two or more of them. The “module” may be interchangeably used with the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific integrated circuit (ASIC) chip, a field-programmable gate array (FPGA), and a programmable-logic device for performing operations which has been known or are to be developed hereinafter.

According to embodiments, at least some of the devices (for example, modules or functions thereof) or the method (for example, operations) according to the present disclosure may be implemented by a command stored in a computer-readable storage medium in a programming module form. When the command is executed by one or more processors, the one or more processors may execute a function corresponding to the command. The computer-readable storage medium may be the memory 130.

The computer readable recoding medium may include a hard disk, a floppy disk, magnetic media (e.g., a magnetic tape), optical media (e.g., a compact disc read only memory (CD-ROM) and a digital versatile disc (DVD), magneto-optical media (e.g., a floptical disk), a hardware device (e.g., a read only memory (ROM), a random access memory (RAM), or a flash memory). In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to embodiments of the present disclosure may be executed sequentially, in parallel, repeatedly, or in a heuristic manner. Further, some operations may be executed according to another order or may be omitted, or other operations may be added.

According to embodiments of the present disclosure, a storage medium having instructions stored therein is provided. The instructions are configured to allow one or more processors to perform one or more operations when executed by the one or more processors. The one or more operations may include identifying a first part in the image, identifying a second part related to the first part based on an identification result of the first part, and performing an operation based on an identification result of the second part.

Embodiments disclosed herein are provided merely to easily describe technical details of the present disclosure and to help the understanding of the present disclosure, and are not intended to limit the scope of the present disclosure. Therefore, it should be construed that all modifications and changes or modified and changed forms based on the technical idea of the present disclosure fall within the scope of the present disclosure.

While the present disclosure has been shown and described with reference to certain embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a processor; and
a memory that stores instructions to instruct the processor to acquire an image including a first object, to identify a first part of the first object in the image, to identify a second part of the first object, related to the first part, based on a result of the identification of the first part, and to perform an operation based on a result of the identification of the second part when the instructions are executed.

2. The electronic device of claim 1, wherein the memory further stores instructions to instruct the processor to determine an area to be identified corresponding to the first part and to identify the second part by identifying an object of the area to be identified when the instructions are executed.

3. The electronic device of claim 2, wherein the memory further stores instructions to instruct the processor to compare the object of the area to be identified with a pre-stored database and to identify the second part based on a result of comparison when the instructions are executed.

4. The electronic device of claim 1, wherein the memory further stores instructions to instruct the processor to perform an authentication by using the identification result of the first part and to perform an operation based on the identification result of the second part and the authentication when the instructions are executed.

5. The electronic device of claim 1, wherein the memory further stores instructions to instruct the processor to perform an authentication by using the identification result of the first part and the identification result of the second part when the instructions are executed.

6. The electronic device of claim 1, wherein the memory further stores instructions to instruct the processor to acquire a depth image corresponding to the image and to perform segmentation between the first part and the second part in the image based on depth information of the acquired depth image when the instructions are executed.

7. The electronic device of claim 1, wherein the memory further stores instructions to instruct the processor to acquire additional information related to the image and to perform an operation based on the identification result of the second part and the additional information when the instructions are executed.

8. The electronic device of claim 7, wherein the additional information includes at least one of metadata of the image and information acquired by the electronic device when the image is photographed.

9. The electronic device of claim 7, wherein the memory further stores instructions to instruct the processor to determine a correlation between the additional information and the identification result of the second part and to output information related to the correlation when the instructions are executed.

10. The electronic device of claim 1, wherein the memory further stores instructions to instruct the processor to determine a size of the first part, determine an area to be identified corresponding to the first part based on the size of the first part, to identify an object in the area to be identified, and to identify the second part when the instructions are executed.

11. The electronic device of claim 1, wherein the memory further stores instructions to instruct the processor to determine an orientation of the first part, to determine an area to be identified corresponding to the first part based on the orientation of the first part, to identify an object in the area to be identified, and to identify the second part when the instructions are executed.

12. The electronic device of claim 1, wherein the memory further stores instructions to instruct the processor to perform pre-processing including at least one of lighting correction, focus correction, and size adjustment on the image when the instructions are executed.

13. An electronic device comprising:
a processor; and
a memory that stores instructions to instruct the processor to acquire an image including a first part, to identify the first part in the image, to identify a second part related to the first part based on an identification result of the first part, and to store the identification result of the first part and an identification result of the second part associated with each other when the instructions are executed.

14. The electronic device of claim 13, wherein the memory further stores instructions to instruct the processor to perform an authentication by using at least one of the identification result of the first part and the identification result of the second part and to store the identification result of the first part and the identification result of the second part associated with a result of the authentication when the instructions are executed.

15. The electronic device of claim 13, wherein the memory further stores instructions to instruct the processor to acquire additional information related to the image and to store the identification result of the first part and the identification result of the second part associated with the additional information when the instructions are executed.

16. The electronic device of claim 15, wherein the additional information includes at least one of metadata of the image and information acquired by the electronic device when the image is photographed.

17. An electronic device comprising:
a processor; and
a memory that stores instructions to instruct the processor to acquire a plurality of images including a first part, to identify the first part in each of the plurality of images, to identify a second part related to the first part in each of the plurality of images based on an identification result of the first part, and to perform an operation based on an identification result of the second part when the instructions are executed.

18. The electronic device of claim 17, wherein the memory further stores instructions to instruct the processor to perform an operation based on a change in the second part in each of the plurality of images when the instructions are executed.

19. The electronic device of claim 18, wherein the memory further stores instructions to instruct the processor to acquire additional information corresponding to each of the plurality of images, to determine a correlation between the change in the second part in each of the plurality of images and the additional information, and to output information related to the correlation when the instructions are executed.

20. An electronic device comprising:
a processor; and
a memory that stores instructions to instruct the processor to acquire an image and to perform an operation related to at least one part of the image based on a type of a first part included in the image when the instructions are executed.
